(19) United States
(12) Patent Application Publication
(10) Pub. No.: US 2005/0154662 A1
(43) Pub. Date: Jul. 14, 2005

(54) Asset allocation, rebalancing, and investment management system

(76) Inventor: James Alan Langenwalter, Pittsburgh, PA (US)

Correspondence Address: COHEN & GRIGSBY, P.C., 11 STANWIX STREET, 15TH FLOOR, PITTSBURGH, PA, 15222, US

(21) Appl. No.: 10/982,736

(22) Filed: Nov. 5, 2004

Related U.S. Application Data
(60) Provisional application No. 60/517,647, filed on Nov. 6, 2003.
(60) Provisional application No. 60/524,571, filed on Nov. 24, 2003.
(60) Provisional application No. 60/517,705, filed on Nov. 6, 2003.

(51) Int. Cl. G06F 17/60

(52) U.S. Cl. 705/35; 705/37

(57) ABSTRACT

A computer implemented or enabled method for providing advisors and/or investment management firms with an asset allocation model manager for advising individual investors. This method enables investment management firms to globally define allocation model sets for use firm-wide by their advisors. It may also provide advisors with a customization process for tailoring these global allocation models to their own client investors. The asset allocation models are tailored to the investment suitability and risk tolerance needs of the investor clients. One object of this invention is to assist advisors and investment management firms in targeting a broad spectrum of investors of virtually all income levels. Transactional fees associated with investing, including transfer agency fees and advisor fees, are greatly minimized as a result of this automated, mass customization tool which groups investors into discrete categories so as to provide them with optimum asset management. As a result of this low cost, less hassle method, advisors and/or investment management firms may advise a broader range of individual investors than otherwise. In one embodiment, the disclosed asset allocation model management system operates as a kernel. However, a plug and play system may be incorporated. In a further embodiments, an ACH system, trading system, record keeping system, and/or communication interface(s) (such as advisor-client investor) may utilized in conjunction with this central kernel. An investor interface is also disclosed. The investor can set up an investment account, monitor investment transactions, self-direct investments or communicate with an advisor to facilitate certain investment transactions.

### CROSS-REFERENCE TO RELATED APPLICATIONS

This application is based upon and claims priority to related applications U.S. Ser. No. 60/517,647, filed Nov. 6, 2003; and U.S. Ser. No. 60/524,571, filed Nov. 6, 2003.

### FIELD OF THE INVENTION

This invention generally relates to the field of financial advisement. Specifically, this invention relates to a computer implemented or enabled system for asset allocation management to assist investment management firms and/or advisors in servicing a broad range of investors through mass replication, distribution, and execution of investment methodologies and advice.

### BACKGROUND OF THE INVENTION

Computer implemented or enabled financial advisor systems are known in the art, but none of them offer dynamic fluidity in terms of adapting the investment portfolio over time to adjust to the investor's needs. Instead, such financial advisor systems are focused on portfolio creation and optimization, focusing on just one point in time and creating an optimal portfolio based upon data entered at one point in time (such as prior to actual investment).

U.S. Patent Application No. 2003/0097324 discloses an investment plan creation tool which presents and compares several options to the investor as a result of investor responses to a targeted questionnaire. U.S. Application No. 2003/0120574 discloses an advisor tool for creating electronic portfolios for investors and a user tool for managing the advisor-created portfolio. U.S. Application No. 2003/0120575 describes an investment planning tool which enables investors to obtain prepackaged investment advice from advisors and/or to create their own investment portfolios. U.S. Patent Application No. 2002/0091605 discloses an investment portfolio optimization whereby asset allocation categories are utilized in displaying potential investment portfolio choices. U.S. Patent Application No. 2003/0088489 discloses an advisor tool for optimizing individual investor portfolios wherein results from an investor risk questionnaire and asset classes of current investment holdings are comparatively analyzed yielding suggested changes to the investor's portfolio based upon the analysis. U.S. Pat. No. 6,292,787 discloses an investment portfolio optimization tool for diversifying investments, thereby alleviating unnecessary investment risk. None of these foregoing inventions dynamically readjust an investor's portfolio in relation to the dynamic reallocation and/or rebalancing of an investor portfolio upon purchase, withdrawal, and/or time considerations (i.e., as the investment goal end date draws nearer). There is a need in the art to maximize the potential of a computer-implemented or enabled financial management system. An advisor must manually manipulate investments to accommodate the investor's changing needs as investment goals change or as the time horizon draws nearer to the investment goal date.

As a result, advisors and/or investment firms have to accommodate to the individual investor's changing needs on an ad hoc basis. As a result, cost efficiency is lowered since advisor fees, investment transactional fees, and the like reflect the time, effort, and attention required to adjust an individual's portfolio to his or her changing needs. Because these fees can be cost prohibitive to an investor, especially one who is not a high net worth individual, that non-high net worth individual is oftentimes in an unadvised situation and may make poor financial choices. Further, advisors and/or investment firms typically charge higher fees than otherwise for those non-high net worth individuals who cannot meet certain minimums.

However, with a cost efficient computer-implemented or enabled method which would automatically accommodate to an individual investor's changing needs on an ad hoc basis, the time, effort, and attention required by the advisor would be greatly reduced. Thus, advisors would not have to impose surcharge fees as a result of non-high net worth individuals not investing a required minimum. A broad spectrum of investors could benefit from such an advancement in the art. Thus, there is a need in the art to provide all investors, regardless of net worth, with a cost effective and efficient investment vehicle for growing their financial portfolio.

Further, investors who are either unadvised and/or who are faced with the dilemma of a static investment portfolio (i.e., one which does not adapt with time or other transactional occurrences, as described above) are at a significant disadvantage as their portfolio is not optimized to the extent that it otherwise could be with an adaptable, dynamic system for managing their finances which considers each transactional event in deciding whether to readjust or stay static. If this need could be addressed, then investors could fully optimize their investments, yielding potentially greater returns and/or positive results (instead of poor investment choices). Thus, there is a need in the art to afford unadvised individuals (such as, but not limited to, non-high net worth individuals) with an effective investment tool and a need for providing all investors with a dynamically updated financial portfolio as a result of ever changing investor needs (as a result of transactional flow, changes in investment goals, or the like).

### SUMMARY OF THE INVENTION

Generally, this invention is a computer implemented or enabled method (hereinafter referred to interchangeably as “method” or “system”) that enables an advisor and/or investment firm to create and manage asset allocation models that encapsulate proprietary investment advice. These asset allocation models are grouped into an asset allocation model set comprising investment vehicles, such as for example funds, at varying proportions and having an associated investment risk level that is linked to a plurality of investors each having investment goals with associated time horizons. The models in the asset allocation set change over time to adjust the level of risk and rate of return as the deadline for the investment goal draws nearer. The system matches an asset allocation model set to an investor based upon the investor's investment profile. The system may optionally be integrated into a back office, record keeping, advisory support, or transfer agency system. This system can be used with a wide array of investments—securities and non-securities alike. Non-securities may include healthcare spending accounts or any other investment vehicle which does not involve securities. Non-securities can be liquid in nature in that individuals can purchase and redeem as needed without penalties. Further, the investment vehicles that can be used with this system include those currently in existence and others to be developed. To illustrate the flexibility of this system in accommodating future investment vehicles, one example is privatized social security. Each investor may individually and/or through his or her employer contribute to a private social security account.

More specifically, the present system assists financial advisors in delivering personalized investment services, on a mass scale through mass customization, to investors. This present invention is a computer implemented or enabled automated asset allocation management system for delivering and managing investment services to multiple investors. The heart of the allocation management is the asset allocation matrix.

The asset allocation matrix comprises the following: (1) at least one asset allocation model which is prepackaged or user defined, wherein the asset allocation model comprises at least two investment vehicles, each comprising a portion thereof to total one-hundred percent; (2) at least two asset allocation model groups, each comprising at least two or more models spanning a unique time horizon which consists of a period of time until an investment end goal date, and (3) at least one asset allocation model set comprising at least two asset allocation model groups, wherein the set comprises an investment portfolio of at least one investor. A data manager manages the matrix by creating the following: creating allocation models for the asset allocation model set, storing the asset allocation model set, linking at least allocation model set to at least one investor account with a database, retrieving the model from the model set for a unique time horizon for at least one investor, and changing the allocation model from an initial time horizon to a subsequent time horizon for at least one investor upon reaching the goal date.

As a result, the mass customization benefits are two-fold: 1) mass utilization of customized, proprietary asset allocation models for particular segments of investors; and, 2) reduced transactional costs, including advisor fees and transfer agency fees, which enable both the advisors/investment firms and individual investors to take advantage of a comprehensive investment management system. Investors include companies, pension plan managers, high net worth individuals or any others interested in investing.

In one embodiment, the system contains prepackaged global allocation models. In another embodiment, the global allocation models may be configured by an administrator. In yet another embodiment, the mass customization may be further refined by advisors to tailor these global allocation models to customized allocation models for use with their client investors. In still another embodiment, the mass customization may be configured by an administrator for use by at least one advisor. The mass customization afforded by this invention is a dynamic, fluid process that adapts to the investor's current and changing needs. Through an investment suitability and risk questionnaire and any other questionnaires which the advisor or investment firm may wish to add, an allocation model set is automatically selected for a particular investor. The investment firm/advisor is free to associate this preselected allocation model set or an alternate allocation model set may be selected for or by this particular investor. As a result, the transactional fees, including advisor, transfer agency, trading system, and electronic fund transfer fees, are reduced due to the utilization of a global template for certain categories of investors with respect to certain allocation model sets (which are created by the advisor). Using this system, previously unadvised investors can access and utilize prepackaged financial advice from licensed advisors to assist them with making investment decisions.

In addition, the allocation model set may change over time as a result of changing investor needs. Whether the investor chooses to purchase assets, make a withdrawal of assets, and/or otherwise modify his or her asset allocation set to accommodate a shortening time window with respect to an approaching end goal date, this adaptable system addresses these changing investment concerns and needs. As a result, this invention fully utilizes the advantages of a computer-implemented or computer-enabled method.

The allocation model set is either preselected by the system or is selected instead by an advisor. The selection process is aided and adjusted to investor profiles. Such profiles are created based upon results from a suitability and risk questionnaire designed to capture investor risk tolerances based on one or more user defined risk tolerance factors. The advisor may complete this questionnaire on behalf of the investor or the investor may complete the questionnaire. The questionnaire is typically designed by an advisor. In general, it comprises a series of questions that are displayed in text or pictorial format to prompt the information helpful to understanding an investor's preference for certain funds or investment vehicle types. A specific allocation model set, containing certain investment vehicles and risk levels pertaining to these investment vehicles, is linked to a particular investor having such investment needs, based upon an analysis of the investor responses. In compliance with governmental regulations, where at least one investment vehicle used in an allocation model set requires the advisor to distribute a prospectus to the investor, the system enables the investor to view the prospectus via the Internet, Intranet, and/or web. Further, when the investor is presented with a question in the questionnaire that asks which investment vehicles the investor wishes to utilize, the investor is presented with electronically readable prospectuses that are transmitted over the Intranet, Internet, and/or web.

Over an advisor designated time horizon, the allocation model set may be rebalanced and/or reallocated over time on an automatic, semi-automatic, or manual basis. Where semi-automatic is selected by the advisor, s/he has the option of canceling any pending rebalancing and/or reallocation transactions prior to their occurrence.

The allocation model set comprises at least two allocation models. Over an advisor designated period of time, the allocation model changes to further adapt to the investor's changing needs—this especially concerns the shortened time window as the investment goal date approaches over time. As a result, over a time horizon, there are certain allocation models which are cycled through depending upon the proximity to the investment end goal date. This system automatically transitions from one allocation model to another as triggered by a specific point in time along the investment time axis.

In yet another embodiment, the advisor and/or investment firm may service not only an individual investor, but also an institutional investor or any other potential investor having a suitability and risk profile which can be determined through a suitability and risk questionnaire. In an additional embodiment, “advisors” may broadly include not only licensed advisors, but all other financial intermediaries that can utilize this method, such as but not limited to brokers, financial advice providers, mutual fund companies, other investment firms, banks, and the like. It is emphasized that this system is not limited only to securities investments, but also to non-securities investments for example, savings accounts, certificates of deposit, investments of semi-precious or precious materials. Investments can be construed to include frequent flyer miles, frequent stay hotel points, and the like.

Further, in another embodiment, the method may be supplemented with a record keeping system, an electronic fund transfer system, trading system, and/or communication interface (e.g., advisor-investor client). The cost and transactional efficiency of this system is further enhanced when these components are plugged into the kernel. As an example, omnibus level trading may occur whereby investments of like identity are aggregated and executed at a designated time, thereby saving transactional costs. The reduced transactional costs are then passed on as a benefit to the investor or any other entity or individual that benefits as an “end user” of this system.

In yet another embodiment, an investor interface is provided to interact with an asset management system. The investor can set up an investment account and can monitor any pending or completed investment transactions. If the investor is advised, the investor may communicate with his or her investor through e-mail or secure messaging. The investor may also receive updates, notices, and other information regarding his or her investment account. Where the investor is unadvised, the investor may select predefined allocation models to accommodate his or her investment goals. The investor may also utilize this system to invest in non-securities, where an advisor is not needed to perform these transactions. In an embodiment, there may be a record keeping, electronic fund transfer, and trading system linked to the system. This investor interface may be utilized by organizations to offer their investment products and services to consumers and/or to offer their other products and services to consumers through an e-commerce facility.

### BRIEF DESCRIPTION OF DRAWINGS

FIG. 1 is an overview of an embodiment of the system and processes of the present invention.

FIG. 2 is a graphical depiction of user processes, specifically administrator and advisor settings.

FIG. 3 is an architectural drawing showing the technical operation of an embodiment of the present invention.

FIG. 4 is a graphical depiction of a hypothetical set of allocation models, different for time periods on a time line, at a given risk level.

FIG. 5 is a table presenting an example of an allocation model set from a time perspective using hypothetical dates for the start, end (goal), and model changes in between.

FIG. 6 is a matrix representation of asset allocation model sets, all of which use the same mutual funds. There are three model sets for each time horizon, and these are referred to as a group. Each of the three is associated with one of the following risk tolerance levels: conservative, moderate, and aggressive.

FIGS. 7a-7d are tables presenting examples of rebalancing an account when the risk tolerance threshold of 7% is exceeded (see FIG. 7a), rebalancing upon purchase (see FIG. 7b), rebalancing as part of a withdrawal (see FIG. 7c), and reallocation to a new model (see FIG. 7d).

FIG. 8 screens 500-A to 500-AH show various display screens, which are representations of those that would be seen by a user (system administrator, investment advisor, or an individual investor) during typical interaction with the system according to an embodiment of the present invention.

FIG. 9 is a matrix representation of the risk profile questionnaire result using one question category where the system automatically links each question category type to allocation model sets.

FIG. 10 is a matrix representation of the risk profile questionnaire result using two question categories where the system automatically links each combination of two question categories to allocation model sets.

FIG. 11a is an example of a question and answer from an investor suitability and risk questionnaire.

FIG. 11b is an example of an image that may be associated with an answer choice in an investor suitability and risk questionnaire.

FIG. 11c is an example of an allocation set assignment as a result of a review of the investor responses to the investor suitability and risk questionnaire.

FIG. 12 is an example of an email message that the system creates and sends to alert an advisor of pending reallocation or rebalancing of an investor account.

FIG. 13 is an example of a secure message that the system creates automatically for direct use by clients/investors via the world wide web.

### DETAILED DESCRIPTION OF THE INVENTION

The present invention is a method directed towards providing a broad spectrum of investors with making professional investment advice in a cost-efficient and computer-implemented or enabled manner. In one embodiment, the system is implemented by at least one advisor and/or an investment firm. In another embodiment, a non-traditional intermediary is the provider of the system and a broker/dealer, mutual fund company, bank brokerage department, insurance company, or a registered investment advisor is integrated with this system. The investment vehicles themselves may be securities or non-securities. Each allocation model represents an investor's portfolio for a given point in time, wherein the specific funds and/or allocations may change with time, depending upon which allocation models the advisor and/or administrator on behalf of the advisory firm has chosen to best suit that investor's needs. Because each portfolio is an allocation model set with more than one investment vehicle, the portfolio is well diversified such that the rate of return is maximized while the level of risk is minimized.

The system is designed to provide an investor with a choice of whether to be advised or unadvised. If the client elects to be advised, the system enables the client to communicate with the advisor via a secure messaging and/or e-mail system, as described below. The system conveys client advice from the initial creation of the investment plan until the end goal date of the investment. In contrast, the unadvised client is a self-directed investor. The system presents the client with professional advice from advisor-selected asset allocation models and model sets that have been arranged to the investor's goals understood based on investor input information, the goals, time horizon, etc., the unadvised client self-directs the path of his or her investment. With respect to either advised or unadvised clients, these individuals have the benefit of receiving professional investment advice, whether prepackaged or administrator and/or advisor created, through the use of allocation model sets.

As a preliminary step to using the system, the investor first sets up an investment account, to determine which allocation models are appropriate for an investor. Personal information such as, but not limited to, contact information, banking information and/or information relating to other electronic fund transfer sources that the investor has access to, and investor profile information is collected by the system. The investor is prompted to complete an investor suitability and risk questionnaire from which an investor profile is determined. Using this information, the advisor uses the system to recommend a portfolio for the investor along with certain investment type(s). Alternatively, the advisor may select an investment portfolio from a listing of possible portfolios as previously defined by the administrator. Or, the client may select an investment portfolio from a listing of possible portfolios as previously defined by the administrator, thereby rejecting the advisor's choice of an investment portfolio. In an alternate embodiment, based upon the investor profile, the advisor and/or client may be presented with possible investment vehicles and/or portfolios of paid advertisers that market their products according to certain investor profiles. Each investment vehicle comprises an allocation model. More than one allocation model comprises an allocation model set. Each allocation model is designated for use with respect to a certain time frame in light of the investment end goal date. The current investment portfolio is reflected by the current allocation model in use for an investor. A broad overview of the investment plan itself is shown through the designated allocation model set, as each allocation model is used for a certain time horizon as it relates to the investment end goal date. The system retrieves information about the investment vehicles from at least one pre-existing back office system which contains such information.

The administrator may either create a global allocation model set or utilize a prepackaged global allocation model set which is pre-installed in a software embodiment of the computer-enabled or implemented system. The administrator created or prepackaged global allocation model set is globally available to all advisors.

Each of the allocation model sets comprise at least two allocation models. Each allocation model itself comprises at least two or more funds or other investment vehicles. Each fund within the allocation model has a certain allocation wherein the investment consists of a certain proportion of a certain investment as defined by the designated allocation amount. As an example, one allocation model set has two allocation models. Each allocation model itself comprises two funds, Mutual Fund A and Mutual Fund B. The allocations of Fund A to Fund B are fifty-percent (50%) each. By allocating among two or more investment vehicles, the investor's investment is diversified such that the rate of return is maximized while the level of risk is minimized. The global allocation model sets which are globally available to all advisors for use in servicing their investors.

The advisor can use the prepackaged or administrator-created global allocation model set by itself or the advisor can modify either allocation model set to adjust to his or her investment style and/or investor's needs. The process of using a prepackaged or administrator-created global allocation model set is further described below. Whether the advisor uses a prepackaged or administrator-created global allocation model set or modifies such a set, the advisor can use that designated allocation model set and link this to at least one or a plurality of investors. A database keeps track of which allocation model sets are associated with which investors. In a preferred embodiment, the database is a relational database.

A unique feature of the system enables the advisor to make multiple changes in investor accounts. This features is when the advisor has linked one or more a global allocation model set, any change the administrator performs on that set will produce transactional consequences with respect to any linked investors to that allocation set. In one embodiment, if an administrator attempts to change a global allocation model set which is linked to at least one investor account, he or she is presented with a warning that these linked investor account(s) will be affected as a result of the change. For example, if the administrator chooses to remove a fund from a global allocation model, s/he effectively modifies the model used by any linked investors. When a record keeping system, trading system, and electronic fund transfer system is linked to the system in this example, this action prompts an automatic redemption wherein an investment vehicle is sold from the investor account and money is deposited into the investor electronic fund account. In the event where the administrator has added a new fund in its place, instead of a redemption occurring, the purchase of the new fund occurs along with a corresponding debit from the investor's electronic fund transfer source.

When the allocation model set is used for an investor, the assets can fluctuate over time. As a result, the actual investor assets and the relative proportions of these investment assets in relation to one another can deviate from the model allocations, and the system makes adjustments to offset these fluctuations. The system manually, semi-automatically, or automatically reallocates and/or rebalances as needed to adjust the actual percent of each asset to reflect the model's percentage for each asset. Where this system is coupled with an optional recording keeping, trading, and electronic fund transfer system, the system manually, semi-automatically, or automatically reallocates and/or rebalances and at the same time performs required investment transactions, credit or debit fund transfers from the linked electronic fund transfer source(s), and updates and/or pulls or pushes data to and from the recording keeping system.

This system may optionally be utilized in conjunction with a record keeping system, an electronic fund transfer system, and a trading platform. In one embodiment, the system is tied to at least one record keeping system containing items such as, but not limited to investor risk and suitability questions, investor profile information, investor account balance where an account is linked to the system, a log of investment transactions for each investor, 401K transaction information, 401K statement information, tax reporting for the investment transactions for each investor, and the like. An electronic fund transfer system, such as but not limited to an Automated Clearinghouse (“ACH”) system, may be optionally tied to this record keeping system to enable an automated, electronic means for electronic funds transfer (influx or efflux of funds from an investor's bank account or other account containing monetary funds). The use of the ACH system enables the system to perform on behalf of the investor electronic funds transfers involving direct debits of savings and checking accounts through the use of debit cards or other authorized electronic debits; further, the use of the ACH system can also enable automatic deduction from direct payroll deposits of the investors. As used in this application, electronic funds transfer (“EFT”) is broadly defined to encompass any electronic means of transferring funds (e.g., online third party payment systems, ACH systems, ATM networks, or the like). Relatedly, there may be an influx only or an efflux only fund system (e.g., a credit card or debit card used to purchase investments) or a credit or funds system which only accepts money in (as opposed to money out). Further, a trading system may also be tied to the EFT and record keeping systems. The trading system may accomplish omnibus level trades, as further described below.

When the record keeping system, EFT, and trading system are coupled with the system, this allows the investor to have automated trade transactions based upon allocation model changes and/or other events, such as but not limited to reallocation and/or rebalancing. In a preferred embodiment, this combined system utilizes omnibus trading. Omnibus trading is utilized where there is a large number of investment transactions for a limited number of investment vehicles. The net purchases are balanced against the net redemptions. The trading occurs in one transaction, efficiently utilizing resources, time, and cost. In an alternate embodiment, dynamic trading may occur, especially where the number of transactions is small.

From an operational perspective, the administrator configures the logistics involved in other administrative tasks relating to computer-implemented or enabled financial advisement, other than those described above. Where a record keeping system is linked to the system, the administrator sets the organization's account service fees, advisor fees, and any other necessary fees such that the advisor and/or investment firm charges the appropriate fees and types of fees. The amount of each fee is determined by the administrator's organization (e.g., an investment firm). Where a record keeping system and an electronic find transfer source is linked to the system, the administrator may set account balance minimums, an initial investment minimum, automatic investment minimum, and a redemption minimum, a withdrawal/redemption service charge, a cash reserve minimum, an NSF (i.e., nonsufficient funds) fee, and any other administrative fees or related items to these fees which are necessary for the advisor and/or investment firm to financially integrate with the system. These fees and other restrictions are set so that the system automatically enforces these rules. Further, where a record keeping system is linked to the system, the administrator can also enter in organizational information that is necessary for financial statements, taxes, necessary reporting to any governmental agencies, and the like.

The above described method is further described below in accordance with an explanation of the appended figures.

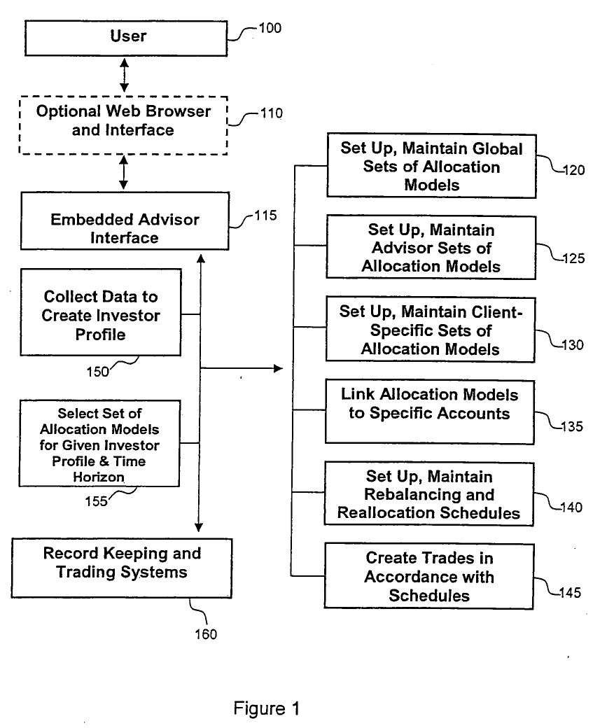

FIG. 1 is an example of an overview of the present invention—a computer implemented or enabled automated asset allocation management system. A user 100 such as an administrator or an advisor interacts with the system through a computer implemented or enabled device with an embedded advisor interface 115. The device has a connection to a network, such as the Internet or an Intranet. An optional web browser and interface 110 enables a user 100 to interact with the embedded advisor interface 115 using a web browser. In one embodiment, the user 100 utilizes a computer-implemented or enabled system which is remotely situated with respect to the embedded advisor interface 115, wherein interface 115 resides on the remote system. User 100 may access the remote computer-implemented or enabled system via the Internet or the Intranet. In yet another embodiment, the user 100 interacts with the embedded advisor interface 115 on the same computer-implemented or enabled system using a web implementation of the embedded advisor interface 115 or a software implementation of the embedded advisor interface 115. Functionally, the embedded advisor interface manages investor accounts, allocates, reallocates, and rebalances investor portfolios, allows for the user to create and/or modify allocation models and model sets, and the like.

The administrator creates an investor questionnaire which comprises questions relating to investment suitability and risk tolerance used to determine what investment types are appropriate and investment risk level is appropriate, for example, conservative, moderate, or aggressive).

In a preferred embodiment, the advisor answers the questions on behalf of the investor, using information s/he previously collected from the investor. In another embodiment, the investor himself or herself answers those questions. The embedded advisor 115 collects the responses to the investment questions and the investor data creates an investor profile for that investor. In one embodiment pertaining to the creation of the specific investor profile, a suitability and risk tolerance questionnaire is also utilized, which questionnaire may be as tailored by the advisor and where applicable, as mandated by the Securities and Exchange Commission (“SEC”) and/or other governmental entities. These questions include an investment goal end date to determine how quickly the investor wishes to achieve his or her discrete investment goal, age of the investor, investment goals, risk tolerance, time horizon, current assets, income required from an investment, and the like. The questions are weighted according to their relative significance and each answer choice of each question is given a value.

In terms of answering the questions, the advisor may answer the questions on behalf of the investor or the investor may answer the questions. The responses to the investor questionnaire are scored based upon the associated weights of the questions and answer choices. The results of this quantitative analysis are used in determining which investment types, in which proportion, and what risk level that are appropriate for matching with the particular investor. This data is collected to create the tailored investor profile 150 for each investor. The system proposes an asset allocation model set which is suited to the investor's needs according to the investor profile 150. The advisor may accept this proposed model set for the investor or s/he may reject the proposed model and select another allocation model set. In one embodiment, the investor questionnaire is responded to as an initial step of the investment process, whereby the responses are used to select an initial allocation model set.

In another embodiment, however, the investor questionnaire may be utilized at a later point in time in the investment process where the investor's needs change. The advisor can change the allocation model set to reflect the investor's changed investment needs.

In an alternate embodiment, instead of a list of discrete, text-based questions comprising the questionnaire, the questions may be in a visual format wherein certain parameters and/or questions are displayed and the user may select an answer from a plurality of answer choices. The answer choices may be finite answer choices such as a risk level. For instance, risk levels include, conservative, moderate, or aggressive answer choices may also be represented within a continuous spectrum of potential answer choices. For example, the question or parameter may relate to age and the potential answer choices range from 18 to 100 years of age—the user may select an age that falls anywhere within this range. Another example of a question/parameter with an associated continuous spectrum of potential answer choices includes desired risk level—instead of being confined to certain risk levels, one can select a numeric value related to the desired risk level such as on a scale of 0 to 5, wherein 0 is most conservative whereas 5 is most aggressive. This “sliding scale” approach provides a more accurate method of characterizing the desired level of risk, compared to characterizing a desired level of risk as conservative, moderate, or aggressive, as many investments fall within a broad spectrum of risk ranging from most conservative to most aggressive. In yet another alternate embodiment, the investor questionnaire may be a combination of “sliding scale” questions and text-based questions. Further, unless otherwise indicated below, where the term “questionnaire” is used, it is to be construed broadly to encompass both of these embodiments (text-based questions and visually formatted questions/parameters).

The allocation model set reflects a certain investment type such as, if using mutual funds, a growth fund, a large cap fund, a small cap fund, an international fund, or the like. Each investment type has an associated level of risk. The advisor chooses a particular allocation model set associated with a certain investment type depending upon the type of investment which the investor chooses to invest in and the risk tolerance level. Risk tolerance levels may be conservative, aggressive, moderate, and various degrees thereof. For example, an investor's profile may indicate that s/he has a moderate risk tolerance level. As a result, the advisor will choose an investment type that reflects this risk tolerance level.

In an optional but preferred embodiment, actions steps 115, 150, and 155 as previously described may be tied to record keeping and/or trading systems 160, ACH and/or other electronic fund transfer systems (not shown), and/or communication interface(s) (e.g., advisor-investor client) (not shown).

Generally, the action steps 115, 150, 155, and 160 (previously described) assist the administrator and/or advisor in setting up and maintaining global sets of allocation models 120, setting up and maintaining advisor sets of allocation models 125, setting up and maintaining client-specific sets of allocation models 130, linking allocation models to specific accounts 135, setting up and maintaining rebalancing and reallocation schedules 140, and creating trades in accordance with schedules 145 and/or creating other investment transactions with schedules (not shown).

The administrator may use prepackaged global allocation model sets (not shown) or the administrator may create his or her own global allocation model sets 120. Where the administrator chooses to create the global allocation model sets 120, the administrator sets up these global allocation model sets. At least two allocation models comprise the allocation model set. The administrator creates at least two allocation models.

The administrator may import a list of available funds and other investment vehicles from a back office record keeping system. From the collection of investment vehicles, the administrator selects investment vehicles to create various allocation models. In one embodiment, the administrator chooses one fund per allocation of each allocation model. The administrator may then designate the allocation percentages of each fund or other investment vehicle. For example, the administrator may select Fund A and Fund B to comprise an allocation model. The administrator then chooses to designate 50% for Fund A and 50% for Fund B. In an alternate embodiment, the administrator can designate a plurality of investment choices per allocation such that an advisor can subsequently choose which investment choice to use in servicing his or her investors. For example, the administrator may select Fund A, Fund B, and Fund C as funds which comprise an allocation model but configure the arrangement of funds such that either Fund A or Fund B can be chosen for one allocation and Fund C can be used for another allocation. For example, Fund A or Fund B can comprise 50% of the allocation model with Fund C comprising the remaining 50% of the allocation model.

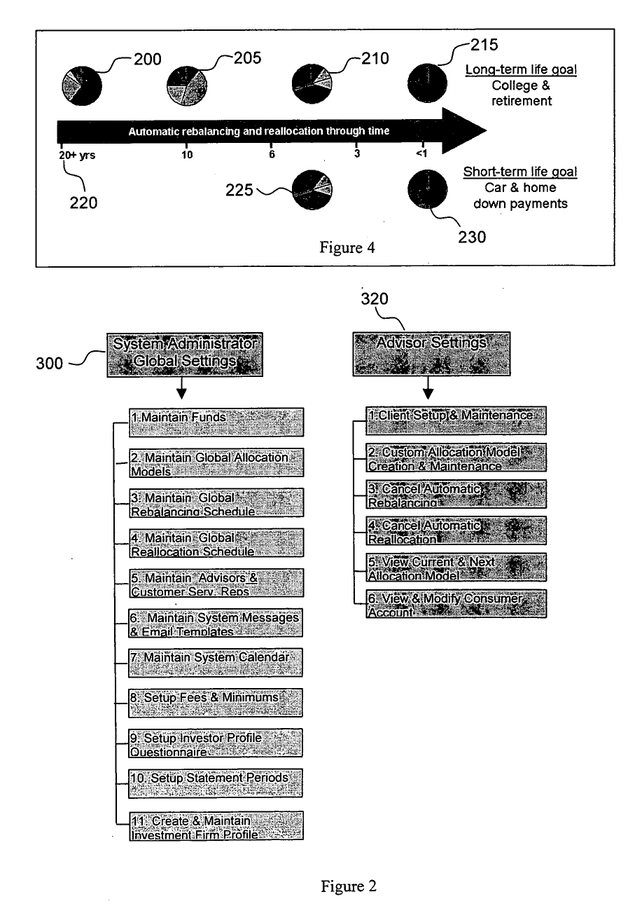

The global allocation models are grouped into a “set” such that the global allocation models are used in a certain defined sequence across a time horizon specific to the investor's needs (this is further explained in FIG. 2, described below). In an alternate embodiment, the administrator creates the initial global allocation model and designates an algorithm for use in calculating the subsequent allocation models in the set. The algorithm generates subsequent global allocation models for use within that global allocation set, based upon administrator input of predefined criteria (e.g., risk level, number of years to goal, etc.). The algorithm takes into account factors such as, but not limited to, age of the investor, current assets, current savings, income required from an investment if any, risk tolerance, and time horizon.

Further, the administrator also designates which advisors have access to the system. In one embodiment, the administrator and advisor may be the same individual. In another embodiment, the administrator and advisor may be different individuals. The separation of administrator vs. advisor roles is further discussed below in FIG. 2.

In setting up advisor sets of allocation models 125, the advisor chooses global allocation model sets and/or administrator created allocation model sets. The system links which model sets a particular advisor uses and keeps track of this using a database.

The advisor can choose certain global allocation model sets as is to service his or her clients, designating these as advisor-owned. Or, the advisor can modify the global allocation model sets 120 in creating the advisor-owned allocation model sets 125 to suit his or her style. For instance, the advisor can add additional investment fund types that are available on the system which are not available through the global allocation model sets 120 as set up by the administrator. Further, the advisor may further refine the advisor-owned model sets 125 by creating client-specific allocation models 130 which are uniquely tailored to the client's needs. The advisor may create and/or edit each allocation model which comprises the allocation model set. In yet another embodiment, the advisor may create and/or edit an initial allocation model and utilize a global (administrator-level) algorithm or an advisor-owned algorithm. In still another embodiment, the advisor can create his or her own algorithms for automatic configuration of an allocation model set based upon an initial allocation model and other predesignated criteria. The algorithm takes into account factors such as, but not limited to, age of the investor, current assets, current savings, income required from an investment if any, risk tolerance, and time horizon.

In another embodiment, in lieu of an algorithm, the advisor may define how much of a percentage change in risk there should be at each time interval along the time horizon. For example, the advisor may wish to choose only a fifteen-percent change in risk level from one allocated model set to another. In another example, the advisor may wish to make the allocation models progressively more aggressive by choosing a negative fifteen-percent change in risk level from one allocation model to another.

The advisor can link the advisor-owned allocation models 125, 130 to client-specific investment accounts 135. The administrator or the advisor can set up and maintain rebalancing and reallocation schedules. The administrator can set up and maintain global rebalancing and reallocation schedules for the global reallocation model sets. The advisor can also set up and maintain asset rebalancing and reallocation schedules 140 for his or her client-specific and/or advisor-owned asset allocation model sets, which may or may not differ from the global rebalancing and global reallocation schedules. Further, the advisor can also set up automatic, semi-automatic, or manual scheduling for rebalancing and reallocation transactions (not shown). Where the scheduling is semi-automatic, the advisor can cancel pending rebalancing and/or reallocation transactions for certain investors; absent this cancellation, these otherwise pending transactions will occur as scheduled.

In an optional embodiment, at least one trading system 145 interfaces with the system such that any investment transactions results of certain asset allocation of investors are executed on a predetermined schedule.

FIG. 2 illustrates the system administrator 300-advisor 320 dichotomy of roles in the system. While the roles are separately defined as shown, one individual may be an administrator and advisor, although these roles may be served by different individuals. The administrator oversees the investment policies of the firm or other organization utilizing the system. The advisor manages investment portfolios for the investors.

As discussed above in the overview in FIG. 1, the administrator 300 of the investment firm can maintain funds by designating which funds will be globally available funds for the global and advisor allocation model sets, maintain global allocation models, maintain a global asset rebalancing schedule, maintain a global reallocation schedule, and maintain an authorized list of advisors and customer service reps with respect to access rights to the system. Additionally, the administrator customizes the templates provided with the system of secure messages and email alerts that the system automatically creates for certain system events. The administrator also maintains the system calendar on behalf of the firm, which determines when system events are started, such as updating transactions processed, trade amounts for redemptions, set statuses, check account balances for rebalancing due, reallocation due, close the day for cash transactions, create ACH payout transactions, transmit omnibus trades to broker/dealer, load today's NAV for each mutual fund, process end of day activities, sweep all fees, post fee transactions, post dividends, capital gains, accruals, etc. Also the administrator sets up and maintains all fees, both periodic and manual result from special service requests, as well as the minimums associated with account balances, account statuses, investments, and redemptions. The administrator sets up the firms Investor Profile Questionnaire in the system such that the appropriate scoring results in the presentation of the correct asset allocation model set. The administrator sets up periods for statements to be automatically available for investors, such as monthly, quarterly, and annual. The administrator also creates and maintains the firm's profile, which includes the firm name, address, logo, key contact names, key telephone numbers and emails, much of which will automatically be posted for use by the investors. For example, a customer service telephone number is kept in the system database so that the system can post it in appropriate places for use by investors.

Also as shown in FIG. 2, the advisor 320 can conduct client setup and maintenance with the system, create customized advisor-owned and/or client-specific allocation model sets, select his or her own rebalancing and/or reallocation schedule including designating whether it is manual, automatic, or semi-automatic, and also has the ability to view the current asset allocation model which is being utilized by a particular client in addition to viewing the next allocation model in the allocation model set as related to that particular client. The advisor can also view and modify the investor's account on behalf of the investor.

A working example of the system is illustrated for example in FIG. 3. Advisor action pages are displayed on a web browser 400 in this example. The web pages which are displayed on the advisor's computer-enabled or implemented device are served through a web server 405. The asset allocation management system is shown in the web server and asset allocation manager application 405, a Simple Object Access Protocol (“SOAP”) 410, the asset allocation manager web services 415, at least one database 420, and an integration manager 425.

The asset allocation manager application 405 runs on top of the web server 405. The Simple Object Access Protocol 410 allows the asset allocation manager application 405 to interface with asset allocation manager web services 415. The database 420 interfaces with the asset allocation manager web services 415 to a database 420 wherein the database information is web-enabled for instance, data can flow in and out of the database through this web interface which connects with 400 (web browser) and 405 (web server, asset allocation manager application). The database 420 keeps track of investor profile information, trades, reallocation/rebalancing schedules, allocation model set associations, and the like—essentially, any information pertaining to administrator, advisor, and/or investor concerns. In an alternate embodiment, the database 420 may comprise a plurality of databases.

An integration manager 425 interfaces with the database 420 and the record keeping transaction server 435. The integration manager's role is to synchronize data between the record keeping transaction server 435 and the database 420. Trades executed, client profile creation and updates, and the like are examples of a few types of synchronized data. Finally, the record keeping transaction server 435 interfaces with, in an optional but preferred embodiment, ACH systems (shown) or other electronic fund transfer systems (not shown) and, also in an optional but preferred embodiment, an omnibus trading system 455. As a result of the record keeping transaction server 435, ACH 450 or other electronic fund transfer system (not shown), and omnibus trades 455 interactions, the system is instructable to automatically execute omnibus level trades of an aggregate of investors at fixed, predefined intervals such that funds required to purchase certain investments are automatically deducted from an investor's account or redemptions to investor's accounts are performed where selling certain investments. Furthermore, like trades and/or investments can be executed at a fixed, predefined time (e.g., all buys of IBM common stock) such that cost and volume efficiency is maximized. The system achieves this by adding the investment transactions to the next day's trading and/or investment transaction list. The net purchases and net redemptions are synchronized in the list so that the net trades for all investors for that day are sent to the designated trading or other investment system. The other investment system may include a broker-dealer (e.g., a gold broker for the purchase of a certain quantity of gold). The investment transactions are settled and cleared through the National Securities Clearing Corporation or other suitable entity.

Transfers of information in between the record keeping transaction server 435, ACH 450 or other electronic fund transfer systems (not shown), and omnibus trades 455 occur via a secure data transfer protocol such as FTP (“File Transfer Protocol”) through automated means (i.e., a batch process such as RJE (“Remote Job Entry”)). The omnibus trades are executed via integration with the investment firm's trading system. National Securities Clearing Corporation (“NSCC”) or another suitable entity may be used for settlement and clearing. In yet another embodiment, where the number of trades are small in number, such trading may occur dynamically.

In an embodiment, the system is designed to interface with any type of back office record keeping transaction server of the user's existing system 435. The interface utilizes an integration manager, such as Application Program Interface (“API”) 425 provided by the record keeping systems for posting trades triggered by the time triggered reallocations and rebalances. The trades for the day are processed not on a dynamic basis, but rather queued up for occurring at a predesignated point in time (e.g., at 11:59 PM each weekday); also, the reallocation and rebalancing for each investor account is modified according to the execution of the investment transaction. In one such example, the record keeping system handles all Automatic Clearing House (“ACH”) and transactions 440, 445, 450, 455. As an alternative to the traditional electronic funds transfer to and from savings and checking accounts using the ACH system, any other form of automated electronic funds transfer may occur (e.g., automatic credit card charge, automated payroll deduction, or any other cash transfer method). The integration manager 425 handles all the necessary transactions to synchronize the system with the record keeping system for these transactions.

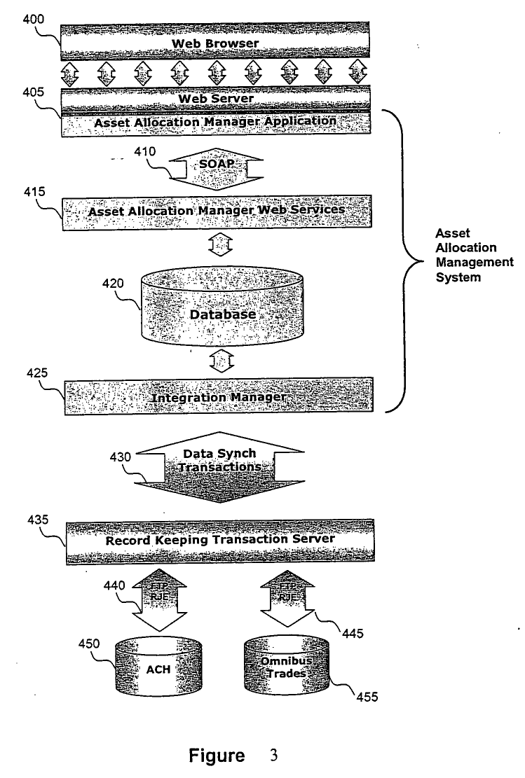

An example allocation model set is shown in FIG. 4. Depending upon the investor's investment goals, the relevant time horizon may be long-term (e.g., 20+ years) or it may be short-term (e.g., 5 years). As discussed above, the advisor can pick and choose which allocation models are appropriate for the specific investor's needs. For instance, allocation models 200, 205, 210, and 215 are appropriate for a long-term 20+ year goal (such as saving for college or retirement). As can be seen in FIG. 4, allocation models 200 and 205 are designated for long-term when the investment goal date is far off in the future (e.g., 10 or more years). However, also shown in FIG. 4, as the goal approaches the models adjust as allocation models 210 and 215 are better suited for shorter term.

As a result, for a long-term life goal such as college and retirement savings, models 200, 205, 210, and 215 are selected by the advisor to fulfill that investor's long-term needs. But, if the investment goal is short-term, models containing progressively more concentrated investments are selected such as 225 and 230, which are used only as these allocation models are more catered to short-term investments (and the level of productivity and risk involved). In a preferred embodiment, as time approaches the investment goal date, the investment risk involved grows more conservative (i.e., involves less risk). Similarly, in a preferred embodiment, as time is farther away from the investment goal date, the investment risk involved entails more risk (and hence the potential for much growth) to help ensure that the investment goal is met by the end goal date. Thus, in these preferred embodiments, risk decreases (and conservativeness increases) along the time horizon axis as the investor's end goal date draws nearer and there is less and less time remaining to recover should any losses occur.

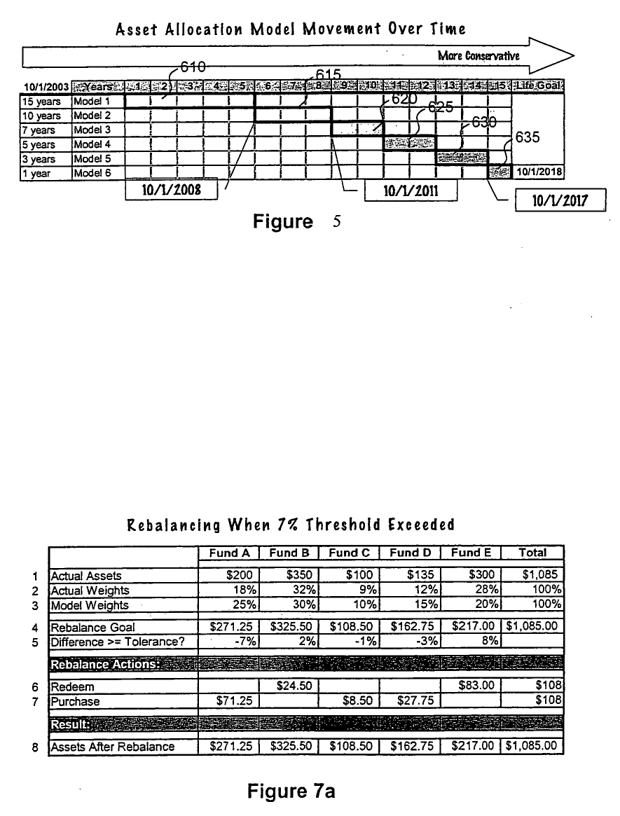

For example, referring to FIG. 5, if a goal is fifteen years from today and the allocation model set contains six models for 11-15+ years to goal, 8-10 years to goal, 6-7 years to goal, 4-5 years to goal, 2-3 years to goal, and 1 year to goal respectively, we begin the count down by allocating our assets in accordance with the 11-15 year allocation model 610 until we reach 10 years from goal. At that point in time, the system automatically moves the assets to the 8-10 year model 615 within that set by initiating reallocation and continues to use that model until we reach 7 years from the goal. At that point in time, the system automatically reallocates the assets in accordance with the 6-7 year model 620 until we reach 5 years from the goal. At that point in time, the system automatically reallocates the assets to the 4-5 year model 625 within that set by initiating reallocation and continues to use that model until we reach 3 years from goal. At that point in time, the system automatically reallocates the assets to the 2-3 year model 630 until we reach 1 year from goal. At that point in time, the system automatically reallocates the assets to the one-year model 635. Specific answers on the suitability and investor profile questionnaire are used by the present system to correlate a client with an appropriate asset allocation model set.

FIG. 6 is previously described.

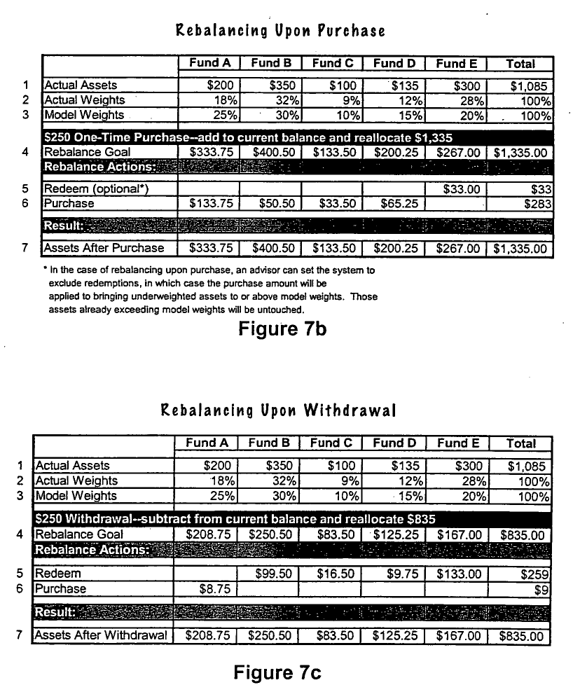

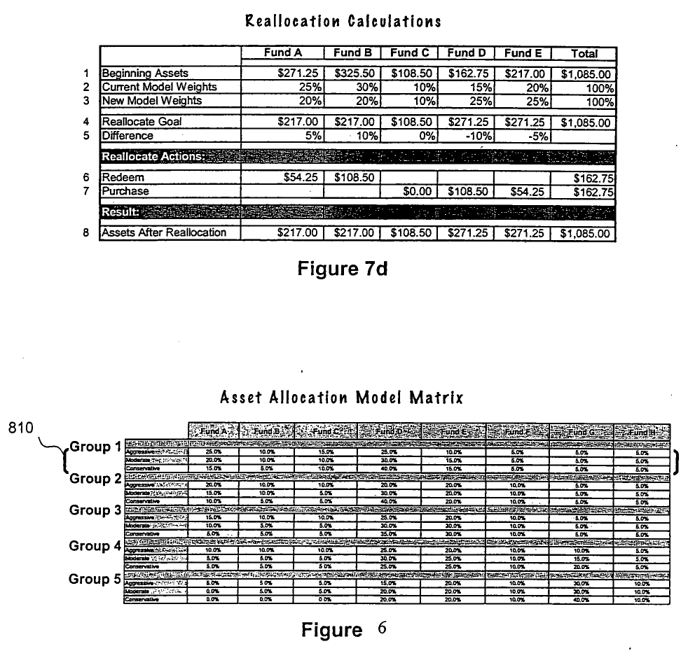

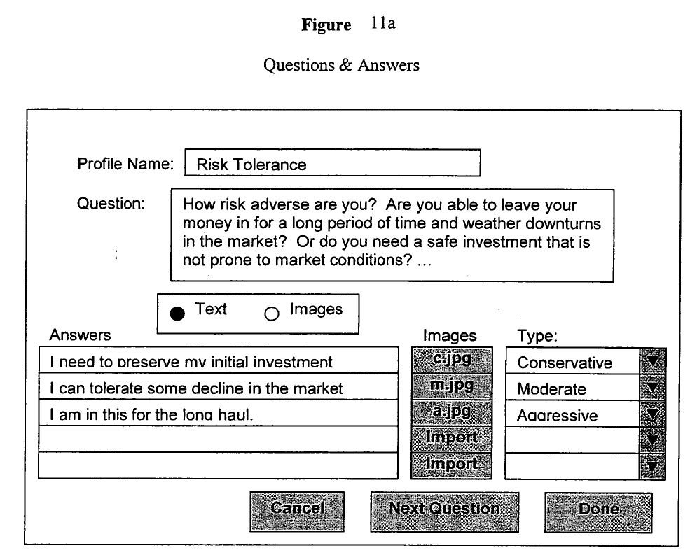

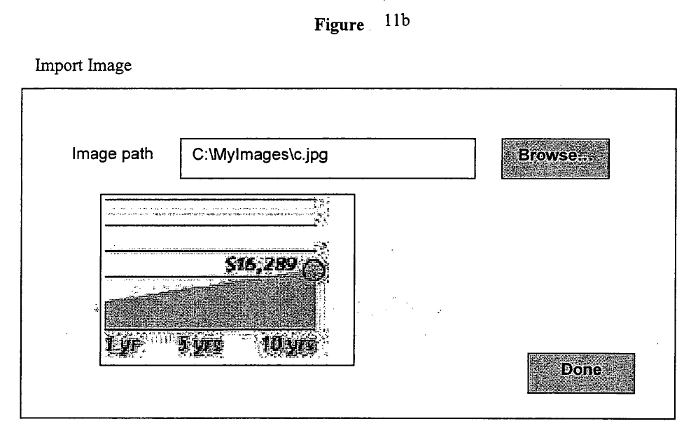

FIGS. 7a-7d illustrate the risk level tolerance threshold with respect to rebalancing, as previously described. Referring to FIG. 7a, as an example, the tolerance or threshold for this asset allocation model set is 7%. This tolerance level is assigned by the creator of the model set to indicate that when the assets in any of the investment vehicles are under or over the prescribed weights for that investment vehicle, such as Fund A and Fund E are per line 5. On the prescheduled date for rebalancing, the system automatically rebalances the account as indicated in FIG. 7a when no advisor is associated with the account or the model set is on automatic. If the model set is owned by an advisor, and the model set is on semi-automatic mode, the advisor is notified FIG. 11 that a scheduled rebalancing is valid (the tolerance threshold has been met or exceeded) and due on a given date. Unless the system receives a cancellation from the advisor, the remaining calculations are done as presented in FIG. 7a, lines 4-5. The rebalance actions, i.e., redemptions and purchases, necessary to bring the account in balance with the model are calculated automatically by the system as in FIG. 7a, lines 6-7 and respective trade requirements are presented to the advisor. Once those trades are authorized by the advisor, executed, and settled, the account is updated accordingly using data transmitted to the present invention from the record keeping system. After rebalancing, the assets in each fund agree with the model weights (see FIG. 7a line 3), which is confirmed by comparing FIG. 7a line 4 and line 8. If the advisor cancels the pending action, the system resets to the next rebalance date, at which time the same notification process is repeated.

The system automatically manages the rebalancing process in terms of calculating the current weights (percentage of the total asset balance) for the amount allocated to each investment vehicle, scheduling, calculating the difference between the actual weights in each investment vehicle, comparing the actual to what the associated model dictates, calculating necessary purchases and redemptions to restore balance, and creating trade orders. In this manner, the advisor is freed of the need to personally monitor his/her accounts for rebalancing and reallocation, but retains control of whether or not such change occurs as scheduled.

The reallocation process is similar to the rebalancing process, except that a different model in the set is used. FIG. 7d presents an example of the calculations that the system does to determine which investment vehicles need to be purchased or redeemed in order for the account to be balanced to the new model weights. Where a fund or other investment vehicle was previously present in a prior allocation model but is no longer present in the new model, that investment is automatically redeemed by the system. Where the system is tied to an electronic funds transfer system (e.g., such as an ACH), a record keeping system, and a trading system, the investment is sold (i.e., redeemed) and proceeds from that, if any, are deposited into the investor's account (which is tied to the electronic fund transfer system).

But, where the investment vehicles are identical in both models in the reallocation process, the system compares the current model weights in FIG. 7d line 2 with the new model weights and calculates the difference (line 5). According to the calculations on line 5, the account holds 5% more of Fund A than the new model dictates, 10% more of Fund B than the new model dictates, exactly the right amount of Fund C, a shortage of 10% of Fund D, and a shortage of 5% of Fund E. Therefore, the system automatically creates the redemption and purchase orders shown in lines 6-7. After these orders are executed, the account will be reallocated as confirmed by line 8 to agree with line 4. If the investment vehicles in the new model are not the same as those in the current model, the investment vehicle columns FIG. 7d are expanded to include the new investment vehicles. Then the same calculations are executed.

The present invention determines for each contribution to an account which of the mutual funds or other investment vehicles will be purchased and in what quantity to as nearly as possible maintain balance with the allocation model weights for each FIGS. 7a-7d. Optionally, if the existing record keeping or transfer agency system maintains the records, the purchases for all accounts are aggregated to arrive at total omnibus trades for each investment vehicle. That is, at the Internet level or other global level, trades concerning a particular investment may be aggregated, thereby reducing transactional costs for all of the investors involved in this particular trade, including advisor fees, brokerage account fees, and other transactional fees associated with the trade. For those accounts that are scheduled to be rebalanced or reallocated, the combination of purchases and redemptions are identified by the system processes FIGS. 7a-7d. If the present invention is set to create omnibus trade orders, all of the purchases and redemptions, regardless of reason, are netted to reduce the aggregate purchases and redemptions of each mutual fund or other investment vehicle to the minimum required. All client level sub-accounting is handled by the investment firm's record keeping or transfer agency system.

Referring to FIG. 7c, when the investor or other account holder decides to withdraw a dollar amount from an investment account, the system automatically picks which investment(s) to redeem in order to redeem that specified amount with an eye towards retaining the investment account allocations to be in line with the model allocations in the current allocation model being used. Next, where the system is coupled with a trading system, the system adds those redemptions to the next day's trade list (consisting of an aggregate of other investors' trades), synchronizes that list with the next day's purchases to net opposing trades 150, and sends the net trades for all investors for that day to the trading system of record. These are referred to as omnibus trades, as discussed above.

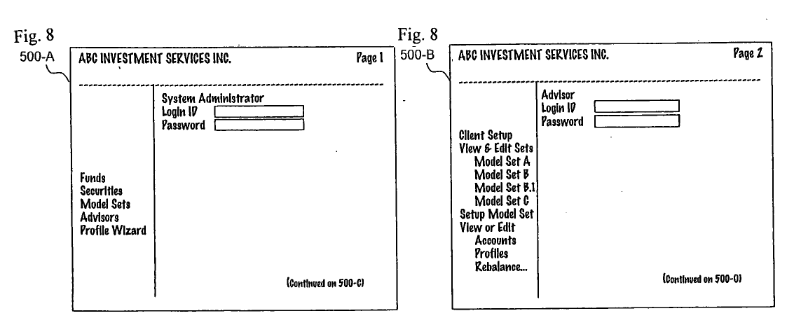

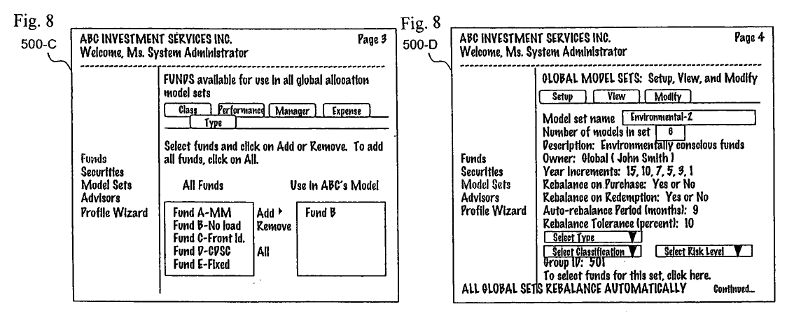

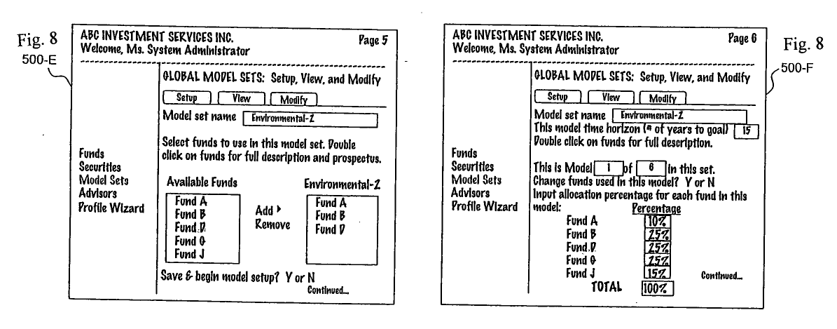

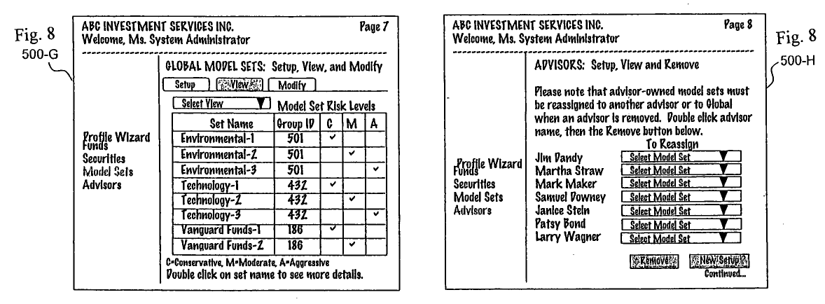

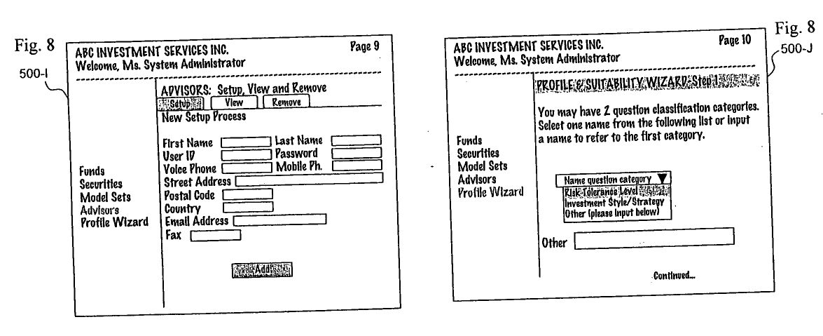

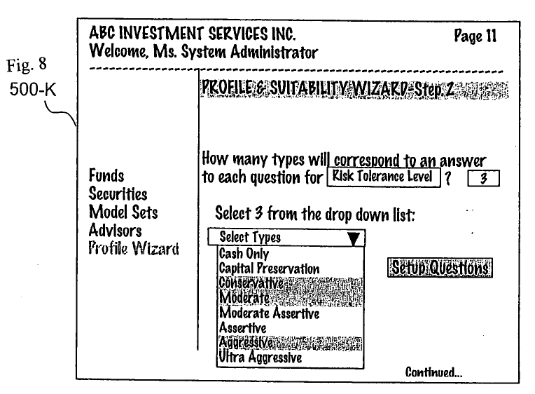

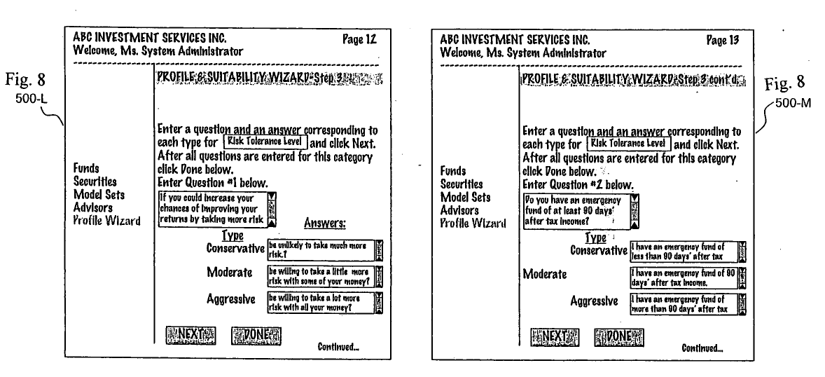

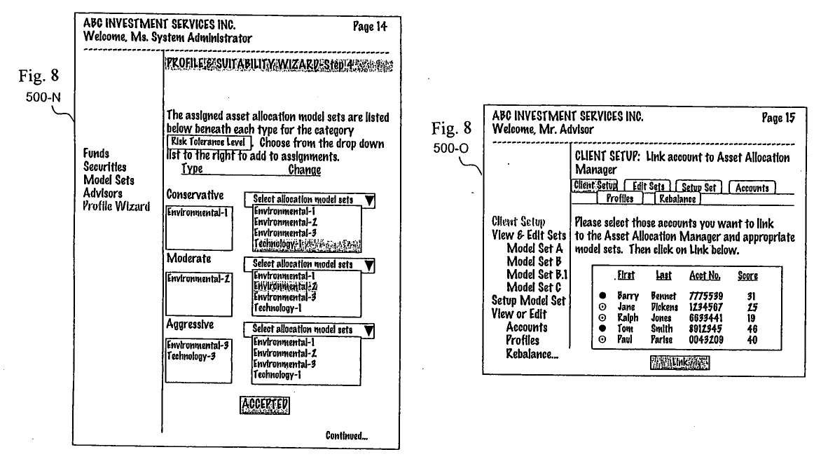

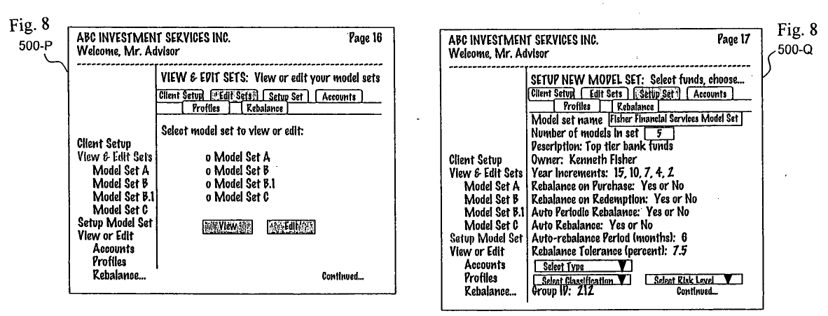

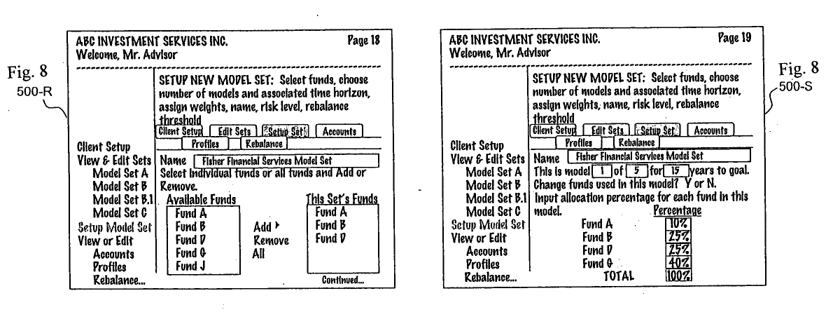

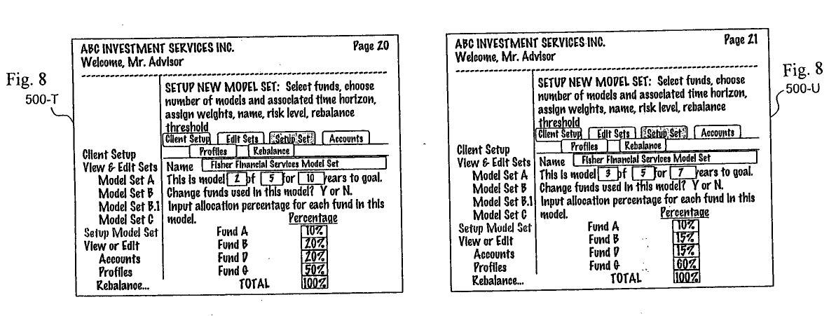

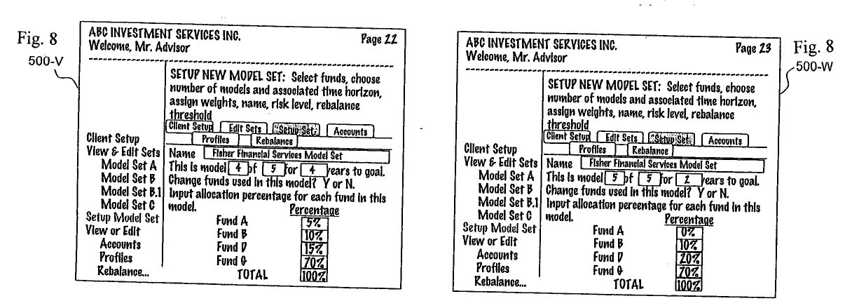

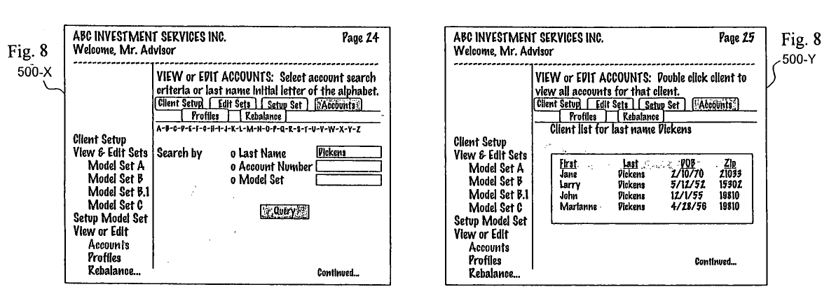

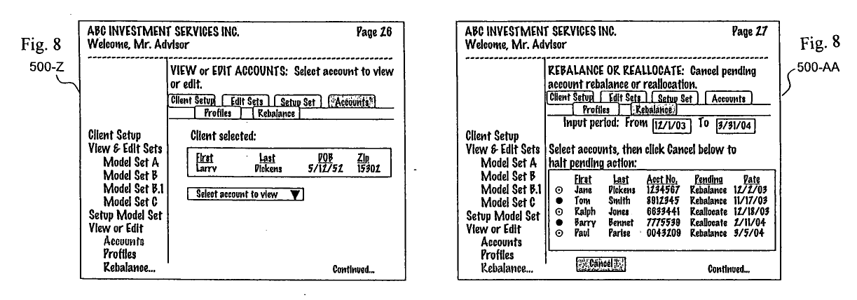

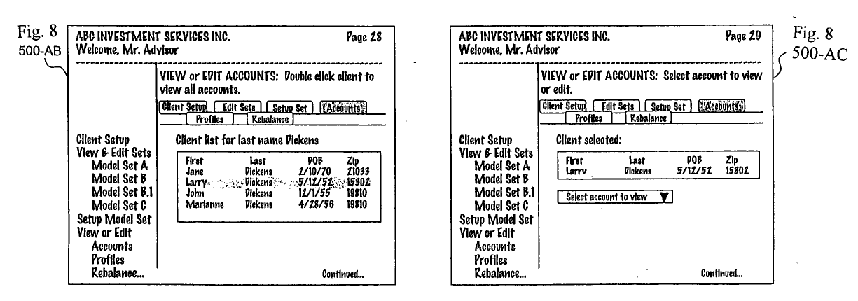

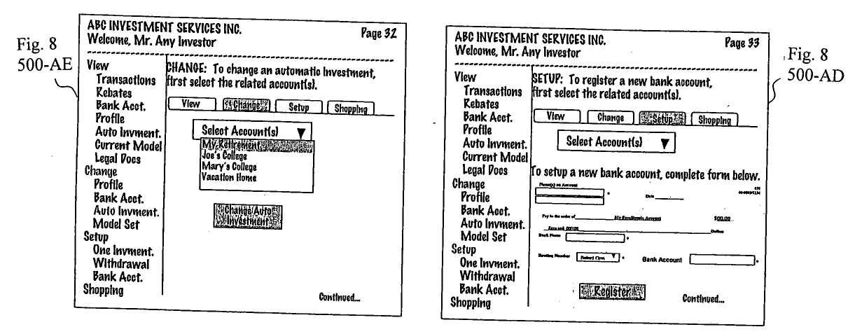

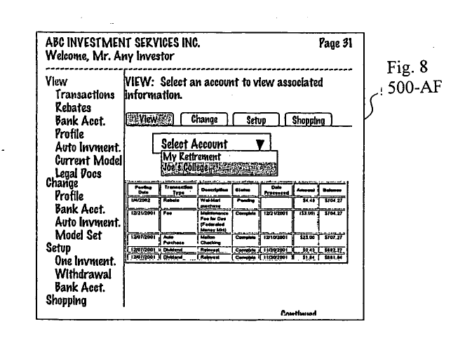

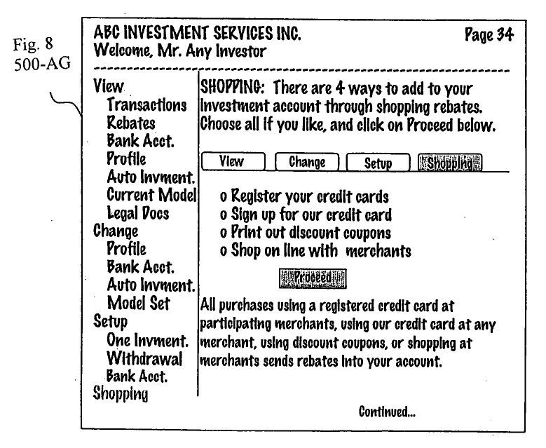

In an example, the system utilizes a graphic user interface (“GUI”) of the system that is depicted in a series of screen displays which are illustrated in FIG. 8. Screen 500-A is an example of an administrator login screen and a list of administrator actions that s/he can take is listed on the left. Screen 500-B is an example of an advisor login screen and a list of advisor actions that s/he can take is listed also on the left.

As shown in screen 500-C, administrators can create global allocation models by selecting funds or other investment vehicles for use in particular global allocation models.

In screen 500-D, the administrator creates a new global allocation model set. The configuration information includes the following: a model set name, the number of models the set contains, a text description of the model set, the owner or creator's name, the relevant investor time horizon as reflected in discrete year increments (shown in descending order), whether rebalancing is desired when contributions to each model are made, whether rebalancing is desired when redemptions are requested, how often periodic rebalancing should occur for this asset allocation model set, and what the rebalance tolerance percent is that will trigger periodic rebalancing. Periodic rebalancing occurs where the rebalance tolerance percent is met or exceeded. The rebalance tolerance percent is reached or exceeded where the actual assets of an investment account of an investor are allocated in such a way where the relative allocations deviate at less than or in excess of the rebalance tolerance percent. See FIGS. 7a-d.

Also as shown in screen 500-D, the rebalancing or reallocation may be manual, automatic, or semi-automatic. Semi-automatic rebalancing or reallocation occurs in the same manner as automatic except that the advisor may cancel certain rebalancing or reallocation events. The administrator selects a classification category for the allocation model set. Examples include “Risk Tolerance Level” (e.g., conservative, moderate, or aggressive) or “Investment Strategy” (e.g., small-cap, mid-cap, large-cap). These classification categories correlate to certain responses from investors in suitability and risk questionnaires.

Depending upon which classification category is chosen in screen 500-D, the administrator selects a certain correlated type. For instance, if “risk tolerance level” were chosen as a classification category, the choices (for “type”) would be conservative, moderate, or aggressive; further, the “Risk Level” option would be grayed out (i.e., disabled) (as this would be redundant). The administrator may then choose aggressive to designate the specific risk tolerance level belonging to this particular allocation model set. However, when “Investment Strategy” in screen 500-D is selected as a classification category, the choices, for example, would be small-cap, mid-cap, or large-cap for the answer type (hereinafter, type). As an example, an investor may choose small cap for investment strategy and conservative for the risk level. The system would propose an allocation model set to the investor's advisor which is a large cap, conservative investment tailored to that investor's time horizon.

It is emphasized that the classification categories and type may be administrator-created. In other words, risk tolerance level and investment strategy are not the only possible classification categories nor are the prior mentioned examples of types the only possible types that may be configured on a particular system.

The group ID in screen 500-D optionally identifies an asset allocation model as one model selected from a group of at least two models having at different risk levels (e.g., conservative and aggressive).

In screen 500-E, the administrator selects the funds or other investment vehicles that comprise the allocation model set—the funds may be the same across all allocation models within the set or they may vary. The same funds or other investment vehicles are presented by the system in each model in the set unless the administrator specifically changes the funds in an individual model. The information relating to available funds may be, in an optional but preferred embodiment, imported from a record keeping system, a transfer agency system, or another similar back office system.

In an alternate embodiment, the administrator can select an initial model for the allocation set and select a global algorithm to automatically create subsequent allocation models for the set based upon predesignated criteria. In still another embodiment, the administrator can create his or her own algorithms for automatic configuration of an allocation model set based upon an initial allocation model and other predesignated criteria. In yet another embodiment, the administrator can edit his or her own algorithms. And in a further embodiment, the administrator can choose a different algorithm for the calculation of subsequent allocation models in an allocation model set. In yet another embodiment, the administrator can edit his or her own algorithms. And in a further embodiment, the administrator can choose a different algorithm for the calculation of subsequent allocation models in an allocation model set.

In screen 500-F, the administrator adjusts the allocations of the funds in each of the allocation models which will comprise the allocation model set. The administrator also can adjust the identity of the funds, if needed. The administrator designates how many allocation models comprise the allocation model set. And, based upon the number of allocation models, the system reiteratively requests input from the administrator for each allocation model which comprises the allocation model set (e.g., 1 of 6, 2 of 6, etc.).

In screen 500-G, the administrator has a bird's eye view of the allocation model sets. The sets can be viewed by risk level, classification category, owner, rebalance preference (i.e., related to rebalance tolerance threshold as discussed above), type, or group (i.e., Group ID). In each view, the administrator can select the asset allocation model set name of his or her choosing and examine details specifically pertaining to the allocation model set (e.g., funds used, allocation percentages, and the like).

The next items at screens 500-H and 500-I, the administrator performs advisor reassignment of allocation model sets shown in screen 500-H, removes advisors from the authorized list (not shown), and sets up new advisors by adding new advisors to the authorized list as shown in screen 500-I. Each allocation model set may be advisor-owned or may be globally owned.

Screen 500-J shows an example of a utility which enables the administrator to create an investor profile questionnaire for risk tolerance and suitability. As shown in screen 500-J, the Profile Questionnaire Wizard (“Wizard”) is used by the administrator to create a custom investor questionnaire. The system prompts the administrator to select or name at least one question category as shown in screen 500-J. Ideally, the name should reflect the category purpose for ease of use. An example of a category is “Risk Tolerance Level.” Another is “Investment Style.” Then, as shown in screen 500-K, the administrator then has to input the number of possible types for each question category and selects what the types are to be. As an example, the question category “Risk Tolerance Level” may be answered with three possible types: conservative, moderate, or aggressive. As an example, the administrator may create a risk tolerance level questionnaire wherein each answer choice of each question correlates to one of the possible answer types—conservative, moderate, or aggressive. Depending upon the overall score of the investor's responses, the overall result may be conservative, moderate, or aggressive. Depending on how the administrator sets up the questionnaire, the results may be scored or averaged (voting method). This overall result is used as the risk tolerance level for the investor.

In screen 500-L, the administrator inputs each question and possible answer(s) for the investor risk and suitability questionnaire. As shown in screens 500-L and 500-M, the system allows the administrator to add on an additional question and answer(s) when the administrator clicks “Next”; similarly, the system allows the administrator to complete the questionnaire setup by selecting “Done.”

The Wizard repeats this process as shown in screens 500-L and 500-M for all question categories as designated by the administrator. An embodiment pertaining to setting up the questionnaire to determine an investor's profile, including the method by which a score is calculated as a result of the investor's responses to that profile is discussed in connection with FIGS. 11a-c (discussed in further detail below).

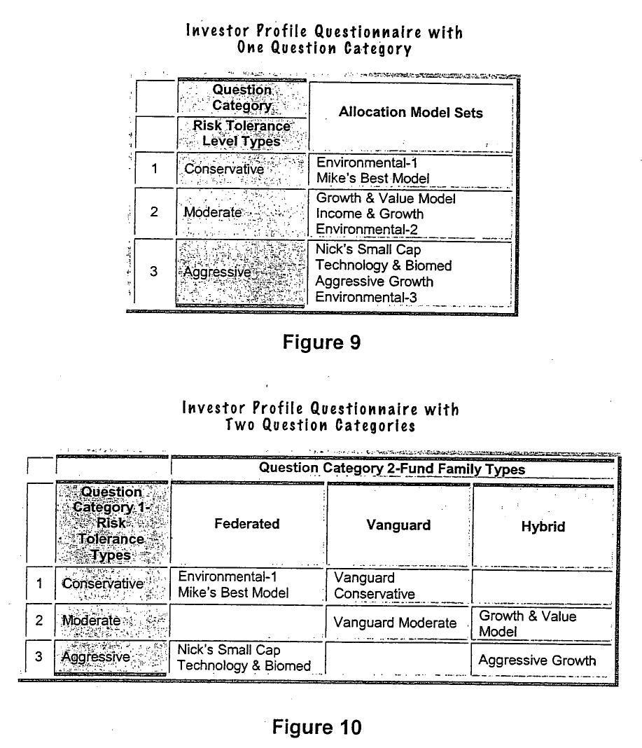

As the final step as shown in screen 500-N, the system associates question categories with certain types, linking this information to the allocation model set risk levels. For instance as shown in FIG. 9, for the question category “Risk Tolerance Level,” the system will link the allocation model sets with certain risk tolerance level types. As a result, when the advisor inputs the investor responses to this question category, where the investor's risk tolerance level is conservative, the proposed allocation model set may be “Environmental-1” or “Mike's Best Model” since the advisor previously designated these allocation model sets as having a conservative risk level. Furthermore, when there is a second question category (such as fund family type), allocation model sets that comprise of funds relating to that particular fund family (in addition to risk level, as described above) are linked, as shown in FIG. 10. The administrator can confirm these associations (described above), as shown in screen 500-N by confirming that the allocation model sets as assigned are accepted (i.e., valid).

Screen 500-O shows an optional embodiment wherein the advisor can make this system available to existing investor accounts by linking investor accounts in existing record keeping, transfer agency, or other systems containing those accounts. This linking process is a method of importing investor account information into the system. The advisor may choose to import one or more investors from a record keeping system into this system.

As shown in screen 500-P, the advisor can view and/or edit allocation model sets. These may be global allocation model sets created by an administrator or advisor-created allocation model sets.

When the advisor chooses to create a new asset allocation model set instead of using the global allocation model set as a template or using a prepackaged global allocation model set, s/he can enter in information about the allocation set as shown in screen 500-Q. The information entered is the same as that described above in screen 500-D where an administrator creates a global allocation model set. The advisor can link at least one of these global allocation model sets for use by at least one investor (not shown). The system proposes one allocation model set based upon an investor's profile score, which the advisor may accept as the default asset allocation model or reject (and instead choose an alternate asset allocation model) (not shown).

Next, in screen 500-R, the advisor selects the finds or other investment vehicles that will be used in the advisor-created asset allocation set. In one embodiment, the system then presents the advisor with each model in the set and its respective criteria in a reiterative fashion as shown in screens 500-S, 500-T, 500-U, 500-V, 500-W, prompts for fund or other investment vehicle changes, and prompts for an allocation percentage of each fund or other investment vehicle. All of the models within the set are presented until the set is complete. In another embodiment, the system prompts the advisor with the initial allocation model in the set. The advisor then selects an algorithm which will generate the subsequent global allocation models in that set. The algorithm takes into account factors such as, but not limited to, age of the investor, current assets, current savings, income required from an investment if any, risk tolerance, and time horizon.

In an alternate embodiment, when the advisor is creating a new asset allocation model set, several investment vehicles may be designated as potential choices for a particular asset allocation within one or more of the allocation models belonging to the asset allocation model set. When the advisor subsequently edits the advisor-created asset allocation model set, s/he can choose one of the potential choices for the particular asset allocation. As an example, when the particular asset allocation involves mid-cap funds and where a client prefers one fund family over another, the advisor will select the fund family which the client prefers when creating a client-specific asset allocation model set. In yet another embodiment, the advisor may create an asset allocation model set wherein each particular allocation of a model is designated one particular investment vehicle or a plurality of potential investment vehicle choices. Where a plurality of potential investment vehicle choices are presented for an allocation of a model, the advisor must pick one of those choices for that allocation. For example, allocation model A may potentially utilize Funds A, B, and C. Funds A and B may be alternatives of each other. In this example, Fund A or B may comprise fifty-percent of the model allocation whereas Fund C may comprise the remaining fifty-percent.

The system then presents views of the investor accounts belonging to the advisor and allows editing of account linkages (i.e., investor account to a particular allocation model set) where no asset allocation models are in use by these accounts as shown in screens 500-X, 500-Y, 500-Z. Account information can be accessed by last name, account number, or model set as shown in screen 500-X. The system provides all investor accounts managed by the advisor as shown in screens 500-Y and 500-Z. Screens 500-Y and 500-Z provide two alternate views of the viewing of investor information. In screen 500-Y, the user selects a client name to list accounts associated with that client name. In screen 500-Z, the advisor can view all client accounts associated with a particular client using a drop down list.

Screen 500-AA shows an advisor action screen for canceling pending account rebalancing or reallocation. The advisor receives a prospective notice of a pending rebalancing or reallocation transaction for a certain client (see FIG. 11). This screen is presented where the advisor has configured the allocation model set to have a rebalance/reallocation schedule (a.k.a. rebalance or reallocation preference) which is semi-automatic.

Since an investor's needs change over time, the asset allocation model must change in order to accommodate those changing needs. Each asset allocation model in a set has a predesignated period of validity. Each asset allocation model is used for a finite period of time; when that time expires, the next allocation model in the set is used. During the use of each allocation model for a certain time period, the investor's assets are managed according to the designated allocation model for that time period. When a record keeping system, trading system, and electronic funds transfer system are associated with the system, trades and other investment transactions are automatically executed in response to maintaining an investor's funds in accordance with the allocation model. Investments are manually, automatically, or semi-automatically redeemed and/or purchased as needed in order to meet the investment goal. In an embodiment, the advisor and/or investor may schedule such investments when the purchases and/or redemptions are semi-automatically (i.e., advisor and/or investor may reject a pending transaction) or manually done. For example, from the point in time where the investor starts an investment plan using the system until the investment end goal date, a unique allocation model is used for each predefined point in time. The risk level varies across the allocation models used over time. Similarly, purchases and/or redemptions are regularly carried out by the system manually, semi-automatically, or automatically in order to ensure that the investor meets his or her investment goal.

Screen 500-AB shows an advisor action screen wherein an advisor can view client accounts by last name. The advisor can select a client name from the general list of clients in 500-AB to render more specific information for that client as shown in Screen 500-AC. The advisor can select an investment account to view of that client from a drop-down menu as also shown in screen 500-AC.

FIGS. 9-10 are previously described (see discussion regarding FIG. 8, screen 500-N).

In an embodiment (not shown), a calendar is maintained by the administrator to identify business days that are to be used by the system for event scheduling (e.g., trade execution, rebalancing, reallocation, or the like). (As described above, the administrator can configure global rebalancing and reallocation schedules. Further, where the system is integrated with (optionally) a trading system, the administrator can configure trading schedules.)

FIG. 11a, previously described above, is an example of a question and answer from an investor suitability and risk questionnaire. FIG. 11b is an example of an image which may used in conjunction with the questionnaire. Specifically, FIG. 11b shows an example of an image showing a conservative investment model in a graph. The user answering the questions in the questionnaire may view the image associated with the conservative investment risk level as an aid in determining whether a conservative approach is best for the individual investment needs.

The questionnaire is used in creating the investor profile. Typically, investment advisors ask clients to complete a suitability and profile questionnaire that contains questions pertaining to their risk tolerance and investment style/strategy with multiple choice answers (including questions such as a written description of the goal, how long to achieve the goal, how much money is needed in an emergency, and the like). In this invention, the advisors input the investor responses to the questions in the system. Each question may be assigned a different weight compared to other questions in the questionnaire, reflecting the importance of each question. Each answer of each question may likewise be assigned a particular weight. In an alternate embodiment, each answer of each question is assigned a particular weight, but each question is not assigned a weight such that all of the answers are totaled according to the assigned weight and divided by the number of questions in the questionnaire.

After the system has analyzed the user responses to the questionnaire, the system proposes an allocation model set. For example, as shown in FIG. 11c, the desired investment sector may be technology. The level of risk for the investor may be aggressive. Based upon an investor profile which reflects these attributes, the system proposes an allocation model set which is characterized by an aggressive technology investment.

In another embodiment, the investor questionnaire may be used subsequent to the creation of an investment plan whereby the investor's needs change and so the allocation model set may need to change to reflect this. In yet another embodiment, the questions can be subsequently modified. In still another embodiment, the weight attributed to each question and/or answer may be modified.

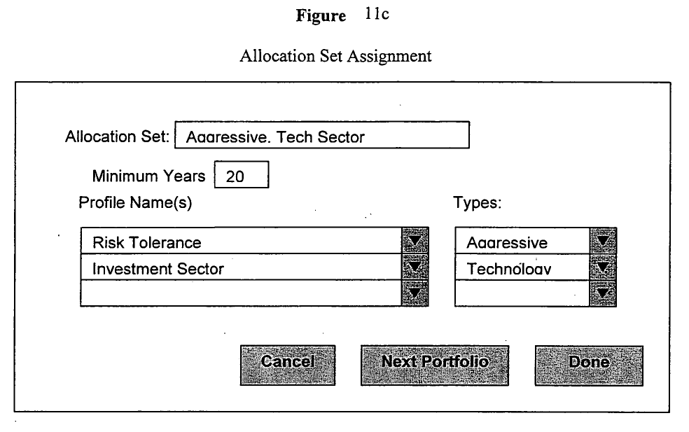

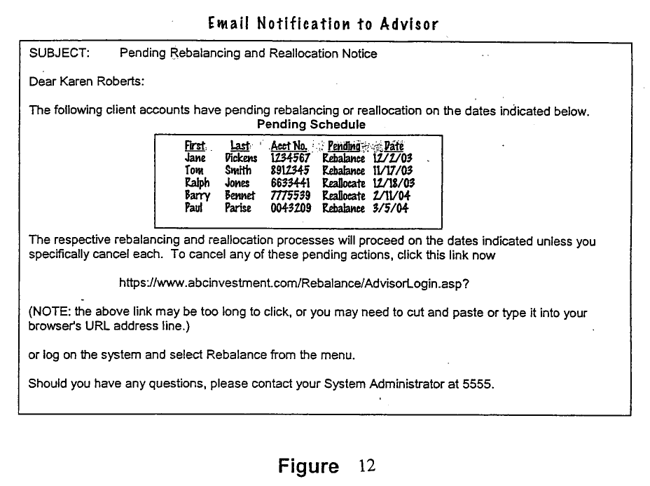

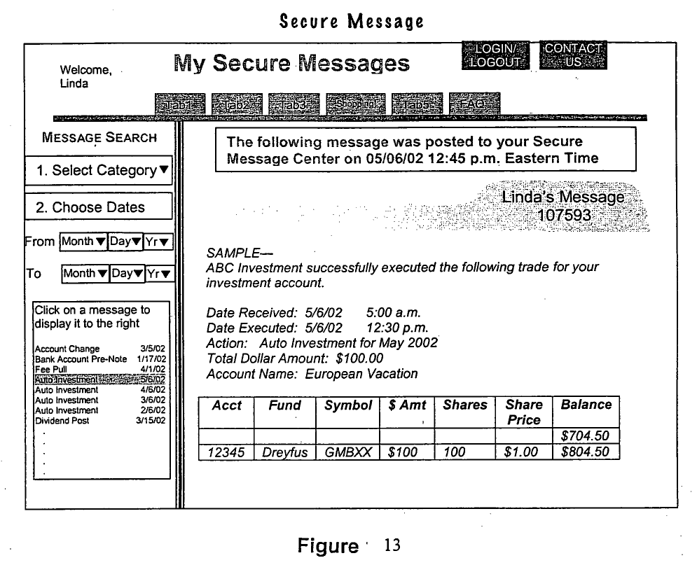

FIG. 12 is previously described, in part, above (FIG. 8 500-AA, FIGS. 7a-d). The administrator can modify prepackaged templates to create customized e-mail messages for advisors pertaining to such events (described above)—e.g., rebalancing, reallocation, pending trades (see, e.g., FIG. 12). Further, the administrator may also create secure message content to advisors and/or clients (see, e.g., FIG. 13). The e-mail (FIG. 12) and secure message content (FIG. 13) may be manually filled in by an advisor and/or client or automatically filled in by the system. In one embodiment, the advisor and/or client may manually fill in e-mail and/or secure message content. In another embodiment, the e-mail and secure message content may be automatically generated by the system where an event occurs which affects an investor account. In yet another embodiment, the e-mail and secure message content may be modified by the administrator and/or advisor, including the data fields which are populated with particular data from at least one database.

In this embodiment, the system has pre-existing e-mail and secure message content templates with data fields which are populated using particular client-specific information retrieved from a database which contains this client-specific information. The secure message content also comes with prepackaged templates. The configuration and look of the e-mail and secure message content may be configured by the administrator. In one embodiment, if the system is integrated with a website or other communications medium that has secure message content capability, then a secure message can be exchanged from advisor to client and vice versa in an interactive fashion whenever transactions or other events of concern occur (e.g., received dividend is reinvested by the system as per the investor's instructions to the advisor).

As an example, where the purchase of a certain fund has been made in accordance with the investor's current allocation model or an automatic investment is executed in accordance with the schedule preset by the investor, s/he is automatically notified by the system via secure message content, wherein the investor received this notice in a secure message format. The secure message format is any format which may be network-accessible only by the investor due to password and other security protections. One example would be a secure website using high encryption technology. When a secure message is posted, the system automatically triggers the appropriate email message to notify the investor that a secure message is now available the next time the investor logs on to the system.

In one embodiment, the secure messaging system is one-way, wherein the system and/or advisor transmits message content to the investor. In another embodiment, the secure messaging system is two-way, wherein the system and/or advisor transmits message content to the investor and where the investor may transmit a response back to the system and/or advisor.

Privacy policies, investment account agreements, terms and conditions, fund prospectuses, a statement of advisor fees and other associated fees and costs, solicitation disclosures, legal forms, and the like, are constantly available to the investor.

In another embodiment of the invention, an investor interface is provided to interact with an asset management system. The asset management system may be an asset allocation management system as described in the foregoing or it may be an alternate asset management system. At least one database integrates the information between the asset management system and the investor interface.

In another embodiment of the invention, a GUI enables the user to keep track of and/or communicate with his or her advisor through certain communication means. To aid in the exchange of client information to the advisor and vice versa, this system incorporates in one embodiment an e-mail messaging system, such as in FIG. 11, a secure messaging system, such as in FIG. 12, or an alternate messaging system, such as but not limited to instant messaging (not shown). As an example, as described above, the investor may himself or herself respond to the investor questionnaire in lieu of the advisor doing so. This may be communicated through the above communication means. Further, the investor may be notified of trades and other investment transactions. Essentially, the investor may communicate or receive communications pertaining to any phase of the investment process vis-à-vis his or her advisor.

In a further embodiment, when an investment vehicle does not involve securities, the system may be self-service wherein an advisor need not be involved in the investment process. As an example, an investor who wishes to invest in certain semi-precious or precious materials (e.g., gold or rare semi-precious stones) may utilize this system to create his or her own allocation model sets (the investor effectively acts as an “advisor” and the above described roles and functions of the advisor apply here). If a record keeping, electronic fund transfer, and trading system is linked to the system, the system can execute any purchases and other transactions pertaining to these non-securities. The “trading system” here should be broadly construed to include, as an example, a broker of semi-precious stones or gold, a bank (wherein the investment may be, as an example, a savings account).

In another embodiment, self-service investors can update their investor profile as life conditions are altered, such as a source of income, a changed income amount, receipt of a large sum of money, a disability or other events that alter financial conditions arise. As a result, the system will re-evaluate which allocation set is appropriate for the investor once the investor profile is changed. The change will be provided to the system in the form of revised answers to the investor profile questionnaire. If a different allocation set fits the new profile, the system will present both the current allocation set and the new one, asking the investor which they would prefer. If the investor accepts the new allocation set, a reallocation event will be scheduled to move the assets in the investor's account to the correct model in the new allocation set.

In yet another embodiment of the foregoing self-service investment scheme, “investment” may be broadly construed to include frequent flyer miles or frequent hotel stay points. When the system includes a linked record keeping, electronic find transfer, and trading system, the “trading system” may be a predesignated hotel which offers frequent hotel stay points for a certain monetary value. Self-management of the allocation model sets occurs using the steps and procedures as previously described. The investor in this case also has the role of “advisor” because this is a self-directed investment.

In still another embodiment, the advisor may advise the investor with securities or non-securities investments, including the foregoing described “self-service” investment schemes.

In another embodiment, the investor sets up through the GUI at least one virtual account. Each virtual account, at minimum, has a finite balance, is capable of storing and withdrawing funds, and has a unique identifier. As an example, the unique identifier may reflect the investor's particular investment goal.

In still another embodiment, where the system is coupled with a record keeping system and an ACH system or other electronic funds source, the investor may, through the GUI, deposit monetary funds from his or her bank account (or other account where monetary funds may be electronically withdrawn) into one or more virtual accounts. FIG. 8, screen 500-AD shows the investor setting up an electronic fund transfer source, such as a bank account coupled with an ACH system, for use with this system. The investor can then set up an automatic investment and/or redemption wherein money is transferred to or from the investor's electronic fund transfer source account to the investor's virtual investment account and vice versa. The investor may have one or a plurality of virtual investment accounts. The virtual investment accounts can reflect the investment type and/or investment goal.

In a further embodiment, where each virtual account correlates to a unique investment goal, the funds available with respect to these particular investments are withdrawn from the specific virtual account. The user accomplishes this by linking a certain virtual account to a certain investment goal. The investment goal is then linked to the relevant asset allocation set. Investment transactions (i.e., purchases and redemptions) occur in accordance with the models within the asset allocation set.

Regular contributions and redemptions may occur on a manual, semi-automatic, or automatic basis from/to an investor's electronic fund transfer source (e.g., an ACH system tied to a bank account) and the investor's virtual investment account. Where automatic investments occur on a semi-automatic basis, the user has the ability to cancel one or more pending transactions (i.e., purchases and/or redemptions). A screen display showing the investor's ability to change an automatic investment is shown in FIG. 8, 500-AE. Further, the investor can view the transactional activity in each investment virtual account. As shown in 500-AF, the investor can view transaction posting dates, types, transaction descriptions, status, date on which the transaction was processed, amount of the transaction, and the balance of the virtual investment account.

In a further embodiment, the investor may view investment transaction schedules, modify the investment transaction schedules, elect to redeem certain investment vehicles, and the like. According to the investor's modifications, the system, by default, will readjust the investor's current portfolio, wherein the investor's current investments are compared with the current allocation model. Purchases and redemptions are made on an as needed basis, in accordance with these instructions of the investor. Alternatively, where the investor wishes to choose an alternate allocation model to better suit his or her needs he/she can override this default action of the system by choosing an alternate allocation model set from a listing of available allocation model sets as created by the administrator.

In yet another embodiment, regardless of whether the investor is self-directed investor, the GUI also includes a web-based e-commerce component wherein the investor may purchase from certain designated merchants. Where the investor purchases from these merchants, the investor earns “cash back” money which is deposited in his or her investment account. Similarly, where the investor purchases from these merchants with a merchant-branded credit card, money is deposited in his or her investment account. Where the investor does both—purchase from a merchant and use a merchant-branded credit card—the investor reaps the benefit two-fold of “cash back” money which is deposited in his or her investment account. Furthermore, discount coupons of designated merchants may be utilized as a further incentive for investors to purchase products or services from designated merchants. FIG. 8, screen 500-AG shows an example of the e-commerce component.

In screen 500-AG, the investor registers the designated merchant credit cards with the system so that the system keeps track of all purchases in the record keeping system and also as a cash back rebate which is deposited into a designated virtual investment account. If the investor does not have a card, s/he can register for a designated merchant credit card to reap these benefits. To further facilitate purchases of goods and services from designated merchants, the investor can print out and subsequently use discount coupons with designated merchants. Further, the investor may access an e-commerce portal which allows the investor to access one or more designated merchant sites for online purchase of goods and services.

A rewards program manager keeps track of the redemptions and/or rewards. When the investor purchases from one of these designated merchants, the merchant returns to the system a cash rebate or reward. The amount of the cash rebate or reward is calculated by a merchant formula and reconciled by the record keeping system to the correct investor account. The method for transferring certain cash from the merchant to the investor occurs through an electronic fund transfer system. Where this is a reward (i.e., not monetary in nature), the reward information is transferred via the record keeping system to the investor account. The merchant keeps track of the reward points for the investor. For example, a consumer may earn, through a purchase at a predesignated merchant, 100 frequent flyer miles with a certain airline. Information pertaining to this is transferred from the merchant through the system to the investor account. The airline itself keeps track of the 100 frequent flyer miles, associated with this particular investor.

While the foregoing has been set forth in considerable detail, the examples and figures are presented for elucidation and not limitation. It will be appreciated from the specification that various modifications to made to the system and combinations of elements, variations, equivalents, or improvements therein may be made by those skilled in the art, and are still within the scope of the invention as defined in the appended claims.

1. A computer implemented or enabled automated asset allocation management system for delivering and managing investment services to multiple investors, wherein said system comprises:
a. an asset allocation model matrix comprising:
i. at least one asset allocation model which is prepackaged or user defined, wherein each said asset allocation model comprises at least two investment vehicles having allocated portions, wherein said allocated portions total one-hundred percent,
ii. at least two asset allocation model groups, wherein each of said asset allocation model groups comprises at least two or more of each said asset allocation model and wherein each of said asset allocation model groups spans a unique time horizon which consists of a period of time until an investment end goal date,
iii. at least one asset allocation model set comprising at least two of said asset allocation model groups, wherein said asset allocation model set comprises an investment portfolio of at least one investor; and
b. a data manager for managing said matrix which comprises:
i. creating each said asset allocation model for said asset allocation model set where said asset allocation model and said asset allocation model set is user defined,
ii. storing said asset allocation model set,
iii. linking at least one said asset allocation model set to at least one investor account with a database
iv. retrieving said asset allocation model from said asset allocation model set for a unique time horizon for at least one investor where said asset allocation model is user defined or prepackaged, and
v. changing said asset allocation model from said time horizon to a subsequent time horizon for at least one investor upon reaching said goal date.

2. The system in claim 1 further comprising:
an allocator for allocating investor assets of an investor to apportion said assets to equal weights in said asset allocation model.

3. The system in claim 1 further comprising:
a rebalancing tool for rebalancing assets when an investor purchases or redeems assets from an investment account, wherein said assets equal weights in said asset allocation model.

4. The system in claim 1 further comprising:
at least one database for associating at least one asset allocation model set with at least one investment account.

5. The system in claim 1 further comprising:
an integration manager for synchronizing transactions between at least one record keeping system.

6. The system in claim 1 further comprising:
an electronic find transfer system for purchasing or redeeming assets from or to an investor account.

7. The system in claim 1 further comprising:
a trading system for executing at least one investment transaction.

8. The system in claim 1 further comprising:
a global allocation model set which is a species of said allocation model set, wherein an administrator creates and maintains said global allocation model set and wherein an advisor can utilize said global allocation model set in servicing investor needs.

9. The system in claim 1 further comprising:
a selection mechanism wherein a user may select all or a subset of funds from a list, thereby constituting a list of available funds for all of the global allocation model sets as managed by said user.

10. The system in claim 1 further comprising:
a global allocation model set wherein a user creates at least one allocation model by selecting at least two funds with at least two different allocations for each of said funds,
a user defined number for the total number of each of said allocation models that comprise said set, and
an algorithm for calculating said allocations of each of said investment vehicles for each said allocation model for each said time horizon wherein each of said allocation models is not already existing in said set to generate succeeding calculated allocation asset models.

11. The system in claim 1 further comprising:
an advisor allocation model set wherein an advisor creates at least one allocation model by selecting at least two investment vehicles with at least two different allocations for each of said investment vehicles,
a user defined total number of each of said allocation models that comprise said set, and
an algorithm for calculating said allocations of each of said investment vehicles for each said allocation model for each said time horizon when each of said allocation models is not already existing in said set to successively generate calculated allocation asset models.

12. The system in claim 1 further comprising:
a global allocation model set wherein an administrator creates at least one allocation model by selecting at least two investment vehicles with at least two different allocations for each of said investment vehicles,
a user defined number for total number of each of said allocation model that comprise said set, and
an user defined percentage change of risk level for calculating said allocations of each of said funds for each said allocation model for each said time horizon where each of said allocation model is not already existing in said set to generate succeeding calculated allocation asset models and where said calculated allocation asset models vary in said risk level by said user defined percentage change of said risk level.

13. The system in claim 1 further comprising:
an advisor allocation model set wherein an advisor creates at least one allocation model by selecting at least two investment vehicles with at least two different allocations for each of said investment vehicles,
a user defined number for total number of each of said allocation model that comprise said set, and
a user defined percentage change of said risk level for calculating said allocations of each of said funds for each said allocation model for each said time horizon where each of said allocation model is not already existing in said set to generate succeeding calculated allocation asset models and where said calculated allocation asset models vary in said risk level by said user defined percentage change of said risk level.

14. The system in claim 1 further comprising:
an advisor allocation model set which is a species of said allocation model set, wherein an advisor copies and/or modifies a global allocation model set to suit his or her investment style and/or investor needs.

15. The system in claim 1 further comprising:
an advisor allocation model set wherein an advisor selects at least one said allocation model set to link to at least one said investor account with said database.

16. The system in claim 1 further comprising:
a graphic user interface which allows an administrator or advisor to alter said allocated portions of said investment vehicles contained in at least one of said allocation models or said allocation model sets.

17. The system in claim 1 further comprising:
a questionnaire wizard for presenting investor profile and suitability questions comprising:
at least two classifications, wherein said classifications comprise risk tolerance level, investment style, or a combination thereof,
at least two answer types for each of said classifications,
at least one investor question corresponding to each of said types,
a first configuration mechanism for selecting an allocation model set to correspond with each said type, and
a second configuration mechanism for linking said one or more investor accounts with a particular asset allocation model set based upon an associated profile score, whereby the system automatically proposes an allocation model set or an advisor selects a substitute allocation model set.

18. The system as described in claim 1 further comprising:
at least one record keeping system for tracking investment transactions, wherein said record keeping system has an integration manager, wherein said integration manager acts as an synchronizing interface between said record keeping system and said embedded advisor by posting pending trades or other investment transactions at a certain designated time to the record system and performing reallocating and/or rebalancing of assets of at least one investment vehicle of at least one investor account wherein the reallocating and/or rebalancing of assets occur as defined in rebalancing and/or reallocating schedules.

19. The system as described in claim 1 further comprising:
reallocating assets of at least one investment vehicle of at least one investor wherein an advisor, administrator, or individual investor reallocates by utilizing a new allocation model,
wherein the difference between a new model weight of said new allocation model and a current model weight of said current allocation model is reflected by a quantitative percentage value other than zero,
wherein said difference is a positive numeric percentage, the difference between the beginning assets compared to the assets existing at the time of applying at least one new allocation model set is calculated to equate to a quantitative value which is defined as a redemption amount and said redemption amount is posted to at least one said record keeping system.
wherein said difference is a negative numeric percentage, the difference between the beginning assets compared to the assets existing at the time of applying at least one new allocation model set is calculated to equate to a quantitative value which is defined as a purchase amount and said purchase amount is posted to at least one said record keeping system,
rebalancing assets of at least one fund of at least one investor wherein an advisor, administrator, or individual investor manually, semi-automatically, or automatically rebalances according to actual model weight compared to actual model weight, wherein said model weight and said actual weight are retrieved from said record keeping system and the quantitative percentage between said model weight and said actual weight is such that a positive percentage value will result in a redemption with a corresponding monetary redemption amount whereas a negative percentage value will result in a purchase with a corresponding monetary purchase amount,
rebalancing assets of at least one fund of at least one investor wherein an advisor, administrator, or individual investor manually, semi-automatically, or automatically rebalances upon purchase of at least one investment, wherein said investment is totaled with all other investments of the investor in the model allocation set and reallocating assets of at least one fund of at least one investor occurs by multiplying totaled investment by a corresponding model weight of an associated fund or other investment, and
rebalancing assets of at least one fund of at least one investor wherein an advisor, administrator, or individual investor manually, semi-automatically, or automatically rebalances upon purchase of at least one investment, wherein said investment is subtracted from the total of all other investments of the investor in the model allocation set to equate to a new total and reallocating assets of at least one fund of at least one investor occurs by multiplying the new total investment by a corresponding model weight of an associated fund or other investment.

20. The system as described in claim 19 further comprising:
a redemption amount defined as a fixed monetary value wherein a trade or other investment transaction is performed by at least one trading system or other investment transaction system such that a particular investment is sold at a certain defined quantity which is equal to the redemption amount, and
deposit of a monetary value of the redemption amount into an account of the affected investor.

21. The system as described in claim 19 further comprising:
said purchase amount defined as a fixed monetary value wherein a trade or other investment transaction is performed by at least one trading system or other investment transaction system such that a particular investment is purchased at a certain defined quantity which is equal to the purchase amount, and
debit of a monetary value of the purchase amount from an account of the affected investor.

22. The system as described in claim 18 further comprising:
a trading system capable of processing omnibus trade transactions wherein net purchases and net redemptions of all investor transactions are synchronized in a trading list so that the net trades for all investors for a certain day are sent to a designated trading system.

23. The system as described in claim 22 further comprising:
an electronic fund transfer source capable of performing automatic, semi-automatic, or manual withdrawal of electronic funds from at least one said electronic funds transfer source of an individual investor for investment purposes, as determined by a designated investment vehicle of a relevant asset allocation model.

24. The system as described in claim 23 further comprising:
automatic, semi-automatic, or manual deposit of electronic funds to at least one electronic funds transfer source of the individual investor, wherein said deposit is derived from the monetary exchange of the selling of at least one or more investments, in whole or in part.

25. The system as described in claim 1 further comprising:
a secure messaging system for notifying an advisor or equivalent thereof of pending rebalancing and reallocation transactions relating to at least one investor,
an approval or rejection mechanism for approving or rejecting the pending balancing and reallocation transactions relating to at least one investor, and
a secure messaging system for notifying the investor of executed investment transactions, including any reallocating or rebalancing transactions.

26. The system as described in claim 1 further comprising:
an optional web browser and interface so that a user can interact with an embedded advisor interface,
the embedded advisor interface with an administrator component and an advisor component which interacts with the optional web browser and interface as well as,
a database for storing and retrieving data relating to the investor profile of each individual investor,
a user selected set of allocation models for a certain category of investor profile and a certain time horizon corresponding to the investment term,
at least one record keeping system,
at least one trading system or investment system,
the allocation models consisting of the group selected from global allocation models, advisor allocation models, and specific client allocation models,
a first module or other mechanism for linking at least one of the allocation models to advisor and/or investor accounts,
a second module or other mechanism for creating and maintaining the rebalancing schedules,
a third module or other mechanism for creating and maintaining the reallocating schedules,
a fourth module or other mechanism for creating and maintaining trades or other investments in accordance with the rebalancing schedules.

27. The system as described in claim 1 further comprising:
an administrator module comprising of the following:
an authentication mechanism wherein an administrator may access said module using a username and a password,
a first selection mechanism wherein said administrator selects all or a subset of predefined funds from a list, thereby constituting a list of available funds for all of the global allocation model sets as managed by the administrator or the functional equivalent thereof,
a second selection mechanism wherein said administrator selects all or a subset of funds as listed in the list of available funds for use in creating at least one of the global allocation model whereby each global allocation model group consisting of two or more global allocation models bears a unique global allocation model set name,
a first configuration mechanism wherein said administrator configures percentage values for each of the funds associated with a particular global allocation model such that the sum total of the percentage values equals one-hundred percent,
a second configuration mechanism wherein an administrator or the functional equivalent may configure multiple global allocation models for association into a single global model allocation set, whereby said global model allocation set bears a unique global model allocation set name,
a third configuration mechanism wherein said administrator configures a global model allocation set to assign the unique global model allocation set name, define the number of global allocation models in the set, define a text description of the model set, define an owner of the model set, define the time points for reallocating and/or reinvesting, choose whether to rebalance on purchase, choose whether to rebalance on redemption, optionally choose a time period for automatic rebalancing, define a percentage corresponding to risk level threshold for rebalancing, select the predefined fund type, select the classification, and select the associated risk level of the funds in the global allocation model set,
a first display mechanism wherein an administrator or the functional equivalent may view all of the global allocation model sets, the associated risk level for each of the sets, and the global allocation model set name for each of the sets,
a fourth configuration mechanism for modifying the set name or associated risk level for one or more of the sets,
a fifth configuration mechanism for creating, viewing, modifying, or removing one or more advisors and their associated information from the system,
a sixth configuration mechanism for creating, viewing, modifying, or removing one or more advisors with respect to association with one or more of the sets
a questionnaire wizard for investor profile and suitability questions comprising:
at least two classifications such as, but not limited to, risk tolerance level and investment style,
at least two types as subcategories of the classifications such as, but not limited to, conservative, moderate, and aggressive,
at least one investor question corresponding to each of the types,
a seventh configuration mechanism for selecting an allocation model set to correspond with the type, such as, but not limited to conservative, moderate, and aggressive
an eighth configuration mechanism for selecting one or more investors for linking said one or more investor accounts with a particular asset allocation model set based upon an associated profile score, whereby the system automatically proposes an allocation model set or the advisor selects the allocation model set
an advisor module comprising of the following:
an authentication mechanism wherein an advisor may access the administrator module with the correct username and password,
a first module for viewing, editing, or removing existing global and/or advisor allocation model sets,
a second module for creating the advisor allocation model sets comprising the model set name, number of models in the set, the description, the advisor owner, the investment time points, whether to rebalance on purchase, whether to rebalance on redemption, whether to automatically periodically rebalance, whether to automatically rebalance, number of months for automatic rebalancing, percentage of the rebalance tolerance, the type, the classification, the associated risk level, and the selection of all or a subset of the available funds, selecting asset allocation percentages corresponding to the selected funds,
a third module for viewing, searching, and/or editing investor accounts which the advisor or functional equivalent thereof manages, and
a fourth module for selectively canceling rebalancing or reallocating transactions for the investor accounts which the advisor or functional equivalent thereof manages.

28. A computer implemented or enabled automated asset allocation management system for delivering and managing investment services to multiple investors through a user interface, wherein said interface comprises:
a. an asset allocation model matrix comprising:
i. at least one asset allocation model which is prepackaged or user defined, wherein each said asset allocation model comprises at least two investment vehicles having allocated portions, wherein said allocated portions total one-hundred percent,
ii. at least two asset allocation model groups, wherein each of said asset allocation model groups comprises at least two or more of each said asset allocation model and wherein each of said asset allocation model groups spans a unique time horizon which consists of number of years remaining until an investment end goal date,
iii. at least one asset allocation model set comprising at least two of said asset allocation model groups, wherein said asset allocation model set comprises an investment portfolio of at least one investor.
b. a data manager for managing said matrix which comprises:
i. creating each of said asset allocation model for said asset allocation model set where said asset allocation model and said asset allocation model set is user defined,
ii. storing said asset allocation model set,
iii. linking at least one said asset allocation model set to at least one investor account with a database
iv. retrieving said asset allocation model from said asset allocation model set for a unique time horizon for at least one investor where said asset allocation model is user defined or prepackaged, and
v. changing said asset allocation model from a prior time horizon to a subsequent time horizon for at least one investor upon expiration of said prior time horizon.
c. an allocator for allocating investor assets of an investor to apportion said assets to equal weights in said asset allocation model.
d. a rebalancing tool for rebalancing assets where an investor purchases or redeems assets from an investment account, wherein said assets equal said weights in said asset allocation model.
e. a graphic user interface for displaying to an investor pending and completed investment transactions, said graphic user interface comprises:
i. a user control for canceling one or more of said pending investment transactions,
ii. a user control for submitting and/or modifying electronic fund transfer source information, and
iii. an e-commerce component for online shopping with at least one of said designated merchants.
